(19) United States
(12) Patent Application Publication
(10) Pub. No.: US 2026/0322011 A1
(43) Pub. Date: Oct. 15, 2026

(54) CONNECTOR MODULE, CONNECTOR DEVICE, MATING CONNECTOR, AND CONNECTOR

(71) Applicant: Panasonic Intellectual Property Management Co., Ltd., Osaka (JP)

(72) Inventor: CHIKARA ITO, Mie (JP)

(21) Appl. No.: 19/466,595

(22) Filed: Feb. 2, 2026

(30) Foreign Application Priority Data
Feb. 25, 2025 (JP) 2025-028307

(51) Int. Cl. H01R 12/77; H01R 12/70; H01R 13/436; H01R 13/506; H01R 13/627

(52) U.S. Cl. CPC H01R 12/77; H01R 12/7023; H01R 12/707; H01R 12/7082; H01R 13/436; H01R 13/506; H01R 13/6278

(57) ABSTRACT

A connector includes a plurality of terminals, a housing that holds the plurality of terminals, and a fixing member. A housing includes, at a front side of the housing, a front part for disposing the plurality of terminals. The connection target member includes a first surface facing connecting parts of the plurality of terminals and a second surface that is a surface opposite to the first surface. The fixing member is attached to the front part of the housing. The fixing member abuts on the second surface of the connection target member.

### BACKGROUND

### 1. Technical Field

The present disclosure relates to a connector module, a connector device, a mating connector, and a connector.

### 2. Description of the Related Art

PTL 1 describes a connector set including a first connector and a second connector. The first connector is, for example, a plug connector to be mounted on a cable such as a flexible printed circuit (FPC) or a flexible flat cable (FFC). The second connector is, for example, a receptacle connector to be mounted on a circuit board.

The plug connector includes a plug housing and a plug terminal held by the plug housing. The receptacle connector includes a receptacle housing and a receptacle terminal held by the receptacle housing. The plug housing is inserted to be fitted into the receptacle housing. The receptacle terminal is conductively connected to the plug terminal in a state where the plug housing and the receptacle housing are fitted to each other.

A housing body of the plug housing includes a top wall, a bottom wall, a pair of side walls that respectively and consecutively connect both ends in a width direction of the top wall and the bottom wall, and a front wall connected to front ends of the top wall, the bottom wall, and the pair of side walls. The bottom wall is formed with a recess in which a coupling region of a cable is housed.

The housing body includes a plurality of partition walls consecutively connected to the top wall, the bottom wall, and the front wall, and a space formed in the plug housing is partitioned into a plurality of spaces by the plurality of partition walls. A plurality of spaces penetrating in a forward-rearward directions are formed in the housing body of the plug housing in this manner. In addition, a plurality of through holes are formed in the front wall of the housing body so as to communicate with the plurality of spaces.

The plug terminal is to be press-fitted (inserted) forward from an opening (insertion port) on the rear end side of a space among the plurality of spaces. The opening on the front end side of the space is an introduction port for introducing a contact point part of the receptacle terminal of the receptacle connector into the space.

The plug connector is mounted on the cable by electrically connecting (mounting) the plug terminal included in the plug connector to a conductor portion of the cable. The plug terminal is mounted on the conductor portion by soldering or the like.

### Citation List

### Patent Literature

PTL 1: International Publication No. 2020/217882

### SUMMARY

In a connector such as the plug connector described in PTL 1, an improvement is desired in the connection reliability of a connection portion between a terminal of the connector and a conductor of a connection target member such as a cable.

An object of the present disclosure is to improve the connection reliability of a connection portion between a terminal of a connector and a conductor of a connection target member.

A connector module according to one aspect of the present disclosure includes a connector and a connection target member. The connector connects to a mating connector by moving relative to the mating connector in a forward-rearward direction. The connection target member has a plate-like shape and includes a plurality of conductors. The connection target member connects to the connector. The connector includes a plurality of terminals, a housing that holds the plurality of terminals, and a fixing member. Each of the plurality of terminals includes a contact part and a connecting part. The contact part is in contact with a corresponding mating terminal among a plurality of mating terminals of the mating connector in a connected state where the connector and the mating connector are connected. The connecting part connects to a corresponding conductor among the plurality of conductors of the connection target member. The housing includes, at a front side of the housing to be on the mating connector side in the forward-rearward direction, a front part for disposing the plurality of terminals. The connection target member includes a first surface facing a plurality of the connecting parts of the plurality of terminals and a second surface that is a surface opposite to the first surface. The fixing member is attached to the front part of the housing. The fixing member abuts on the second surface of the connection target member.

A connector device according to one aspect of the present disclosure includes the connector module and the mating connector. The mating connector includes the plurality of mating terminals and a mating housing that holds the plurality of mating terminals. The front part and the fixing member of the connector are housed in a mating recess that is open to a rear side of the mating housing in the connected state where the connector and the mating connector are connected.

A mating connector according to one aspect of the present disclosure connects to the connector module. The mating connector includes the plurality of mating terminals and a mating housing that holds the plurality of mating terminals. The mating housing includes a mating recess on a rear side for housing the front part and the fixing member of the connector in the connected state where the connector and the mating connector are connected.

A connector according to one aspect of the present disclosure connects to a connection target member, the connection target member including a plurality of conductors and having a plate-like shape and connects to a mating connector by moving relative to the mating connector in a forward-rearward direction. The connector includes a plurality of terminals to be respectively connected to the plurality of conductors of the connection target member, a housing that holds the plurality of terminals, and a fixing member. Each of the plurality of terminals includes a contact part and a connecting part. The contact part is in contact with a corresponding mating terminal among a plurality of mating terminals of the mating connector in a connected state where the connector and the mating connector are connected. The connecting part connects to a corresponding conductor among the plurality of conductors of the connection target member. The housing includes, at a front side of the housing to be on the mating connector side in the forward-rearward direction, a front part for disposing the plurality of terminals. The fixing member is attached to the front part of the housing. The front part and the fixing member include a first holding mechanism that holds the fixing member with respect to the front part at a first position where a distance in an up-down direction between the fixing member and the plurality of terminals is relatively long, and a second holding mechanism that holds the fixing member with respect to the front part at a second position where a distance in the up-down direction between the fixing member and the plurality of terminals is relatively short.

The present disclosure has an advantage that the connection reliability of the connection portion between the terminal of the connector and the conductor of the connection target member can be improved.

### BRIEF DESCRIPTION OF THE DRAWINGS

FIG. 1 is a perspective view of a connector device according to an exemplary embodiment of the present disclosure as viewed from above in a connected state where a connector and a mating connector are connected;

FIG. 2 is a perspective view of the connector device as viewed from above in a state where the connector is removed from the mating connector;

FIG. 3 is an exploded perspective view of a connector module in the connector device as viewed from above;

FIG. 4 is an exploded perspective view of the connector module as viewed from below;

FIG. 5 is a top view of the connector module in a state where the connection target member is removed from the connector;

FIG. 6 is a sectional view of the connector module;

FIG. 7 is a perspective view of a first terminal included in the connector as viewed from the right;

FIG. 8 is a perspective view of the first terminal as viewed from the left;

FIG. 9 is a perspective view of a second terminal included in the connector as viewed from right;

FIG. 10 is a perspective view of the second terminal as viewed from the left;

FIG. 11 is a perspective view of a housing included in the connector as viewed from above;

FIG. 12 is a front view of the housing;

FIG. 13 is a sectional view taken along line XIII-XIII in FIG. 12;

FIG. 14 is a perspective view of the housing as viewed from below;

FIG. 15 is a front view of the connector in a state where a terminal and a front seal member are attached to the housing;

FIG. 16 is a sectional view taken along line XVI-XVI in FIG. 15;

FIG. 17 is a sectional view taken along line XVII-XVII in FIG. 15;

FIG. 18 is a sectional view taken along line XVIII-XVIII in FIG. 15;

FIG. 19 is a view for describing a method for assembling the connector module, which is a perspective view in a state where the terminal and the front seal member are attached to the housing as viewed from below;

FIG. 20 is a view for describing a method for assembling the connector module, which is a perspective view as viewed from below in a state where, to the housing, the first seal member is attached, and a fixing member is temporarily attached, from the state of FIG. 19;

FIG. 21 is a view for describing a method for assembling the connector module, which is a sectional view in the state of FIG. 20;

FIG. 22 is a view for describing a method for assembling the connector module, which is a perspective view as viewed from below in a state where the connection target member is disposed in a through hole of the housing from the state of FIG. 20;

FIG. 23 is a view for describing a method for assembling the connector module, which is a perspective view as viewed from below in a state where the fixing member is fully attached from the state of FIG. 22;

FIG. 24 is a view for describing a method for assembling the connector module, which is a sectional view in the state of FIG. 23;

FIG. 25 is a view for describing a method for assembling the connector module, which is a perspective view as viewed from below in a state where an elastic member is attached to the housing from the state of FIG. 23;

FIG. 26 is a view for describing a method for assembling the connector module, which is a sectional view in the state of FIG. 25;

FIG. 27 is a view for describing a method for assembling the connector module, which is a perspective view as viewed from below in a state where a pressing member is attached to the housing from the state of FIG. 25;

FIG. 28 is a perspective view of a main part of the connector module as viewed from above;

FIG. 29 is a perspective view of the mating connector in the connector device as viewed from above;

FIG. 30 is a sectional view of the connector device in a connected state where the connector and the mating connector are connected;

FIG. 31 is an exploded perspective view of a rear seal member included in the connector device of Modification 1;

FIG. 32 is a perspective view of the connector module included in the connector device of Modification 2 as viewed from below in a state where a second seal member is removed; and

FIG. 33 is a perspective view of the second seal member of the connector module included in the connector device as viewed from above.

### DETAILED DESCRIPTIONS

=Hereinafter, an exemplary embodiment of the present disclosure will be described with reference to the accompanying drawings. The following exemplary embodiment is merely one of various exemplary embodiments of the present disclosure. The following exemplary embodiment can be variously changed in accordance with factors such as a design, as long as the object of the present disclosure can be achieved. The drawings described in the following exemplary embodiment are schematic representations, and ratios of sizes and thicknesses of components in the drawings do not necessarily need to reflect actual dimensional ratio.

### (1) Exemplary embodiment

### (1.1) Overview of Connector Device

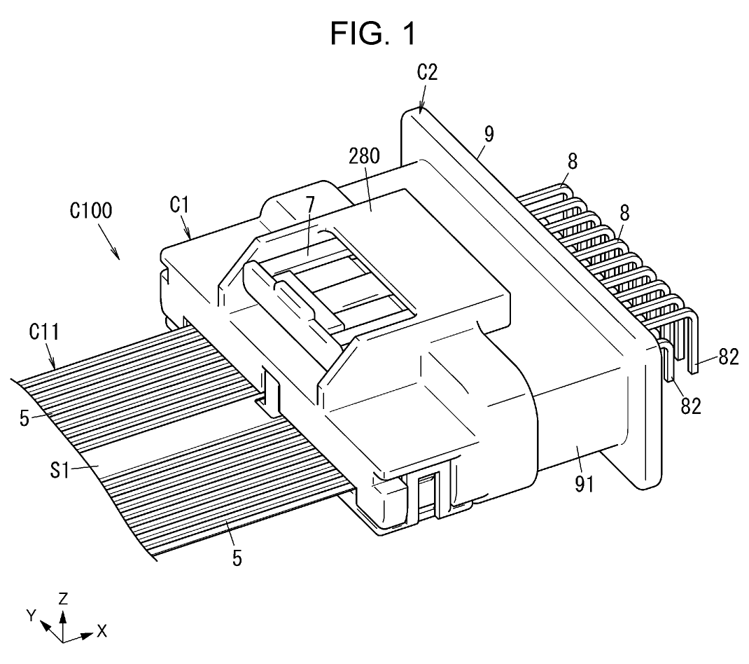

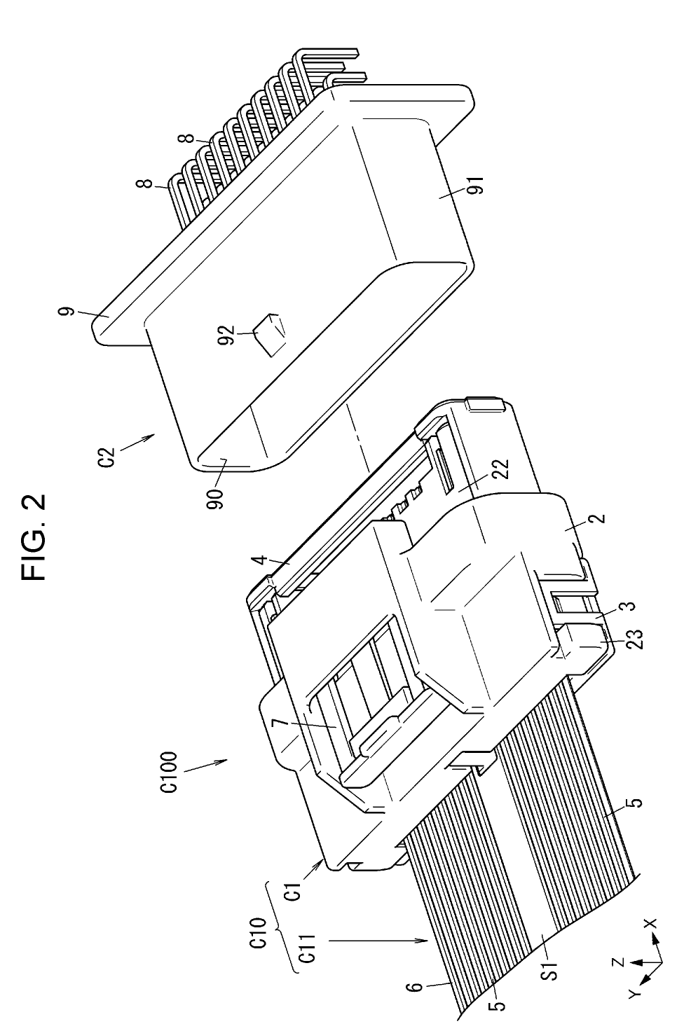

As illustrated in FIGS. 1 and 2, connector device C100 (connector set) of the present exemplary embodiment includes connector module C10 and mating connector C2 (receptacle connector).

As illustrated in FIG. 2, connector module C10 includes connector C1 (plug connector) and connection target member C11 (cable) having a plate-like shape to be connected to connector C1.

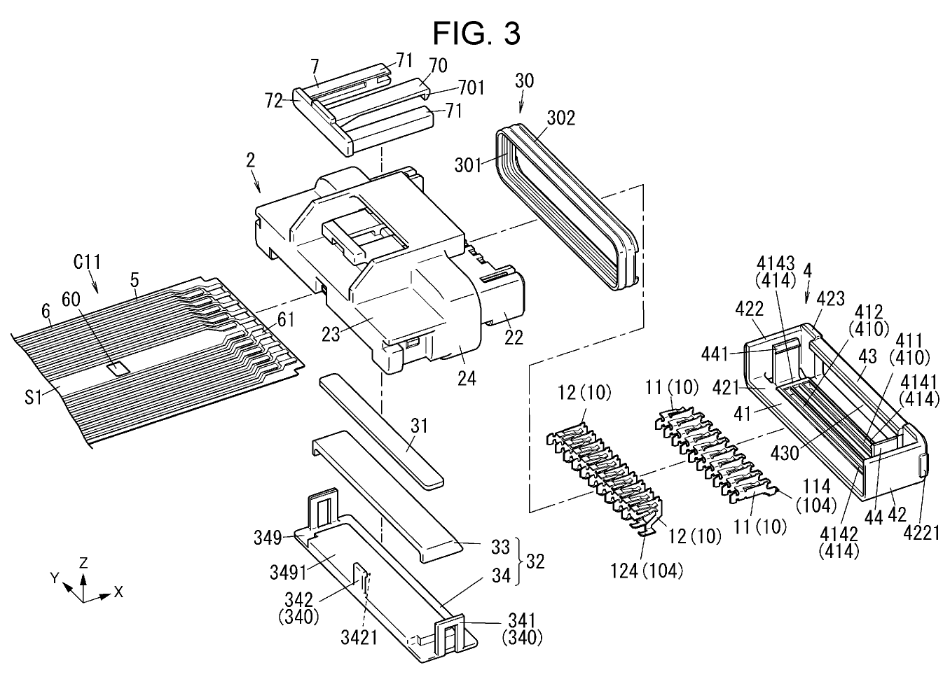

As illustrated in FIG. 3, connector C1 includes a plurality of terminals 10 and housing 2 that holds the plurality of terminals 10. Connection target member C11 includes a plurality of conductors 5.

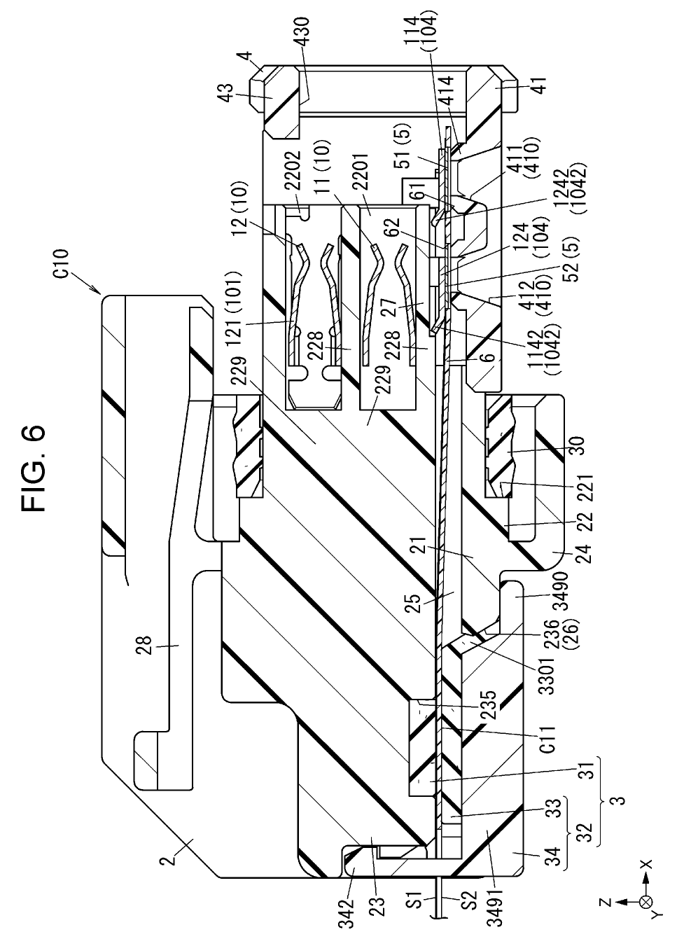

The plurality of terminals 10 of connector C1 connect to the plurality of conductors 5 of connection target member C11, respectively (see FIG. 6). This connects connector C1 and connection target member C11 to each other to form connector module C10. The plurality of conductors 5 of connection target member C11 are connected to an external first electric component on the side opposite to connector C1. The first electric component is, for example, a first circuit board, but is not limited thereto, and it may be another connector component or the like.

As illustrated in FIGS. 1 and 2, mating connector C2 includes a plurality of mating terminals 8 and mating housing 9 that holds the plurality of mating terminals 8. The plurality of mating terminals 8 of mating connector C2 are connected to an external second electric component. The second electric component is, for example, a second circuit board, but is not limited thereto, and it may be another connector component or the like. Mating housing 9 of mating connector C2 may be a part of an external housing that houses the second electric component, that is, mating housing 9 may be formed integrally with the external housing.

As illustrated in FIG. 2, mating housing 9 of mating connector C2 includes mating recess 90 that houses a part of housing 2 of connector C1.

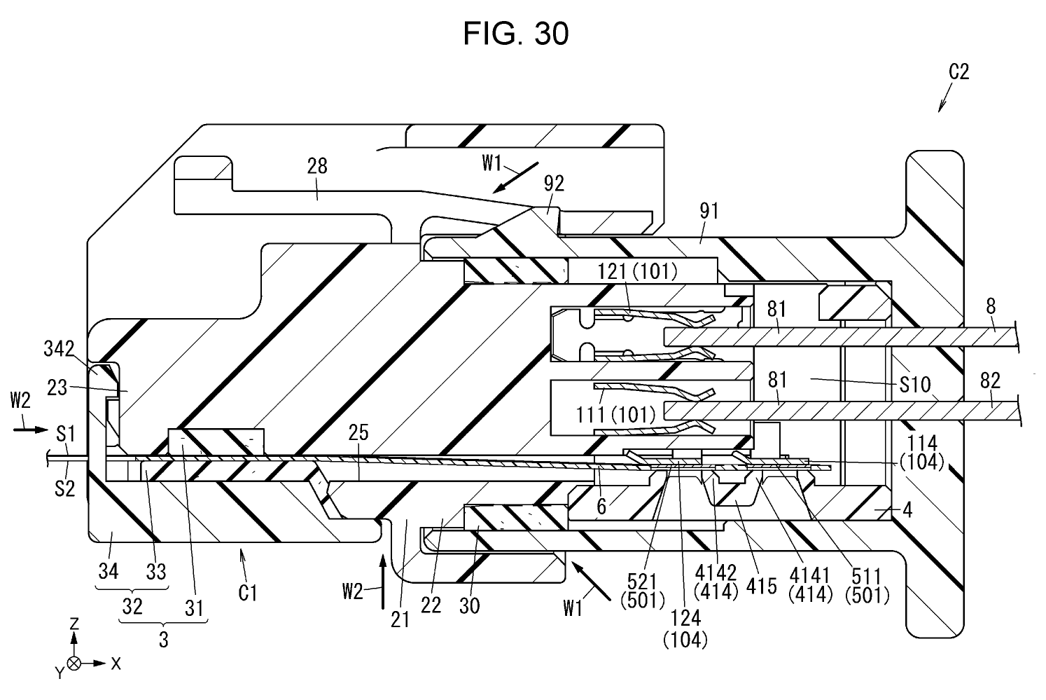

Connector C1 connects to mating connector C2 by moving relative to mating connector C2 along one direction. That is, when connector C1 and mating connector C2 relatively move along one direction, a part of housing 2 fits into mating recess 90 of mating housing 9. At this time, the plurality of terminals 10 of connector C1 respectively connect to the plurality of mating terminals 8 of mating connector C2 (see FIG. 30). This connects connector C1 and mating connector C2 to each other (connected state). When connector C1 and mating connector C2 connect to each other, the first electric component and the second electric component electrically connect to each other.

Connector device C100 can be used, for example, in an application in which waterproof properties and dust-proof properties are required in a vehicle.

Hereinafter, for the sake of convenience in description, as illustrated in FIG. 1, three axes (X-axis, Y-axis, and Z-axis) of a right-handed three-dimensional orthogonal coordinate system will be defined and described as follows with respect to connector device C100. That is, a direction in which connector C1 and mating connector C2 relatively move when connector C1 and mating connector C2 are connected is defined as an X-axis direction. A direction orthogonal to the X-axis direction and along the height of connector C1 is defined as a Z-axis direction. A direction orthogonal to both the X-axis direction and the Z-axis direction and along the width of connector C1 is defined as a Y-axis direction. For the sake of convenience in description, the X-axis direction is defined as a forward-rearward direction, the side where mating connector C2 is positioned with respect to connector C1 (positive orientation of the X-axis) is defined as “front”, and the opposite side is defined as “rear”. The Y-axis direction is defined as a left-right direction, the positive orientation of the Y-axis is defined as “left”, and the opposite orientation is defined as “right”. The Z-axis direction is defined as an up-down direction, the positive orientation of the Z-axis is defined as “up”, and the opposite orientation is defined as “down”. However, the definition of the axes and directions in the present disclosure merely indicates a relative positional relationship between the members of connector device C100, and does not limit the orientation of connector device C100 at the time of use or the like.

### (1.2) Connection target member

First, connection target member C11 will be described with reference to FIGS. 3-5. Connection target member C11 connects to connector C1 to constitute connector module C10 together with connector C1.

Connection target member C11 has a plate-like shape. As illustrated in FIGS. 3-5, connection target member C11 has a thickness along the up-down direction, a width along the left-right direction, and a length along the forward-rearward direction, and has a sheet shape (flat plate shape). Connection target member C11 has first surface S1 (upper surface) and second surface S2 (lower surface) in the up-down direction (thickness direction). Connection target member C11 has flexibility, and it is possible to bend (curve) connection target member C11 in the thickness direction.

Connection target member C11 may be, for example, a flexible printed circuit (FPC). Connection target member C11 only needs to be a plate-like member including a plurality of conductors, and it may be, for example, a flexible flat cable (FFC).

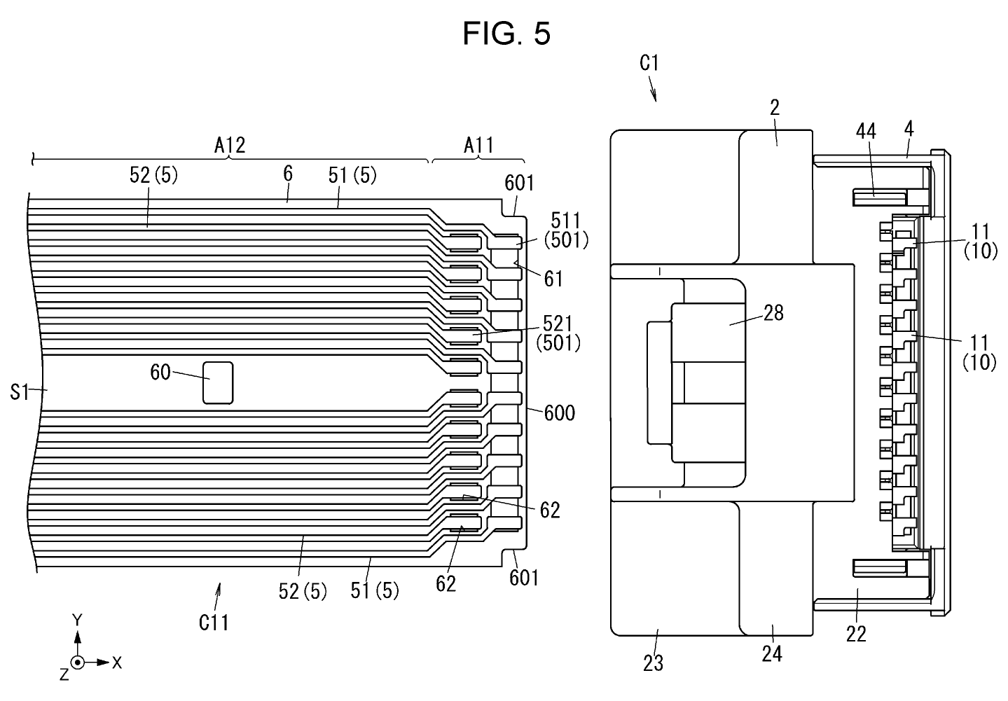

As illustrated in FIG. 5, connection target member C11 has coupling region A11 used for coupling with connector C1 and extension region A12 in which conductor 5 extends for wiring with the external first electric component.

As illustrated in FIG. 5, connection target member C11 includes base material 6 and a plurality of (here, 20) conductors 5.

Base material 6 is an insulator film having electrical insulation properties. Base material 6 has a plate-like shape and has a sheet shape (flat plate shape) elongated in the forward-rearward direction.

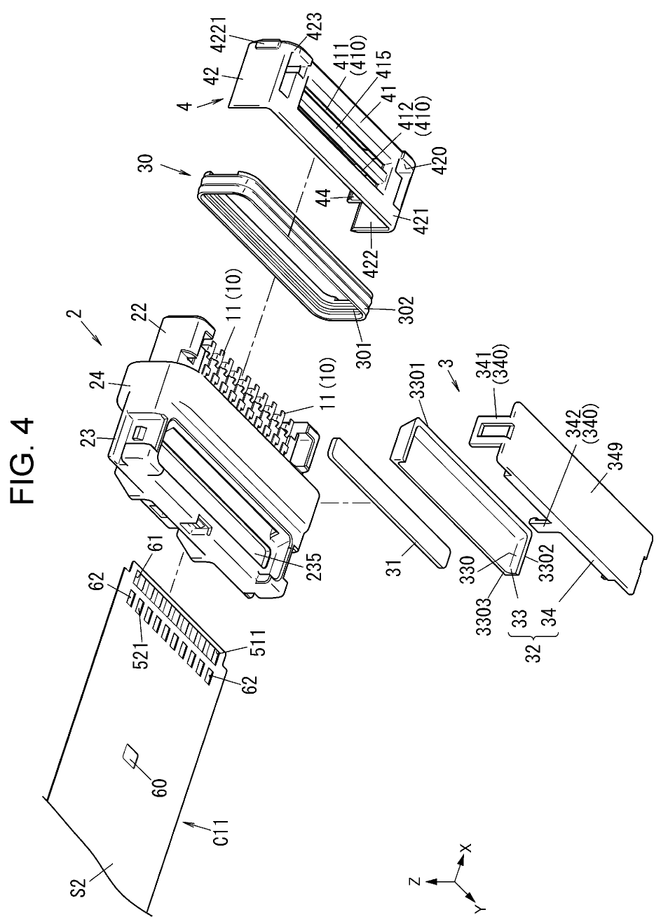

First opening 61 is formed near the front end of base material 6. First opening 61 penetrates base material 6 in the thickness direction (up-down direction) of base material 6. First opening 61 is formed to be long in the width direction (left-right direction) of base material 6 (see FIG. 4), and here, has a rectangular shape elongated in the left-right direction.

Near the front end of base material 6, a plurality of (here, 10) second openings 62 are formed behind first opening 61. The plurality of second openings 62 penetrate base material 6 in the thickness direction (up-down direction) of base material 6. The plurality of second openings 62 are provided side by side in the width direction (left-right direction) of base material 6. Here, the plurality of second openings 62 are arranged at equal intervals. Each of the plurality of second openings 62 has a rectangular shape elongated in the forward-rearward direction. Here, the dimension of second opening 62 in the forward-rearward direction is the same as the dimension of first opening 61 in the forward-rearward direction. The right edge of rightmost second opening 62 among the plurality of second openings 62 is aligned with the right edge of first opening 61. The left edge of leftmost second opening 62 among the plurality of second openings 62 is aligned with the left edge of first opening 61.

Near the front end of base material 6, opening part 60 is formed further behind the plurality of second openings 62. Opening part 60 penetrates base material 6 in the thickness direction (up-down direction) of base material 6. Opening part 60 is provided at the center in the width direction (left-right direction) of base material 6. Here, opening part 60 has a rectangular shape elongated in the left-right direction. Connection target member C11 has opening part 60 penetrating in the up-down direction like this.

The plurality of conductors 5 is provided on base material 6. Each of the plurality of conductors 5 is a conductor film having conductivity. The plurality of conductors 5 are a plurality of pattern conductors respectively corresponding to the plurality of terminals 10 of connector C1. The plurality of conductors 5 are not electrically connected to each other.

Each of the plurality of conductors 5 is, for example, a conductor film printed on the upper surface of the insulator film constituting base material 6.

As illustrated in FIG. 5, each of the plurality of conductors 5 extends in the length direction (forward-rearward direction) of base material 6 on the upper surface of base material 6. The plurality of conductors 5 are provided side by side in the left-right direction on the upper surface of base material 6.

As illustrated in FIG. 5, in extension region A12 of connection target member C11, 10 conductors 5 among 20 conductors 5 are provided at equal intervals in a region on one side (right side) in the width direction of base material 6. Remaining 10 conductors 5 among 20 conductors 5 are provided at equal intervals in a region on the other side (left side) in the width direction of base material 6. The set of 10 conductors 5 on the right side and the set of 10 conductors 5 on the left side are provided apart from each other in the left-right direction so as to avoid opening part 60 formed in base material 6. In the region behind the opening part 60, the 10 conductors 5 on the right side and the 10 conductors 5 on the left side may extend obliquely so as to approach the center in the left-right direction, and thus, the 20 conductors 5 may have equal intervals in the left-right direction in a region further behind.

As illustrated in FIG. 5, in coupling region A11 of connection target member C11, the plurality of conductors 5 extend obliquely such that conductors 5 on the right side and conductors 5 on the left side approach the center in the left-right direction.

Here, the plurality of conductors 5 include at least one (here, a plurality of) first conductors 51 and at least one (here, a plurality of) second conductors 52. The number of first conductors 51 and the number of second conductors 52 are equal to each other, and they are 10 each here.

Each first conductor 51 extends obliquely forward from the front end of the portion of extension region A12 of this first conductor 51 in coupling region A11. Each first conductor 51 has first connecting part 511 near the front end thereof. First connecting part 511 has a rectangular shape elongated in the forward-rearward direction. First connecting part 511 extends in the forward-rearward direction so as to bridge between the front edge and the rear edge of first opening 61 of base material 6. Thus, the lower surface of first connecting part 511 is exposed downward through first opening 61 of base material 6 (see FIG. 4). First connecting parts 511 of the plurality of first conductors 51 are disposed side by side, here at equal intervals in the width direction (left-right direction) of base material 6.

Each second conductor 52 extends obliquely forward from the front end of the portion of extension region A12 of this second conductor 52 in coupling region A11. Each second conductor 52 has second connecting part 521 near the front end thereof. Second connecting part 521 has a rectangular shape elongated in the forward-rearward direction. Second connecting parts 521 of the plurality of second conductors 52 and the plurality of second openings 62 of base material 6 have a one-to-one correspondence. Second connecting part 521 extends in the forward-rearward direction so as to bridge between the front edge and the rear edge of corresponding one second opening 62 among the plurality of second openings 62. Thus, the lower surface of second connecting part 521 is exposed downward through second opening 62 of base material 6 (see FIG. 4). Second connecting parts 521 of the plurality of second conductors 52 are disposed side by side, here at equal intervals in the width direction (left-right direction) of base material 6.

Hereinafter, unless otherwise specified, first connecting part 511 of first conductor 51 and second connecting part 521 of second conductor 52 may be referred to as "conductor-side connecting part 501".

The front end of each of the plurality of first conductors 51 is held by a portion on the front side with respect to first opening 61 in base material 6. The front end of each of the plurality of second conductors 52 is held by a portion (a portion between first opening 61 and second opening 62) on the rear side with respect to first opening 61 and on the front side with respect to the plurality of second openings 62 in base material 6. Base material 6 has tip 600 that is formed on the front side with respect to the front ends of the plurality of conductors 5 and integrally holds the front ends of the plurality of conductors 5. Since base material 6 has tip 600, the front ends of the plurality of conductors 5 are less likely to be separated. This facilitates insertion of connection target member C11 into through hole 25 (described later) of housing 2. As illustrated in FIG. 5, rectangular cutout 601 is formed on both the left and right of tip 600 in base material 6.

Connection target member C11 may further include a covering part having electrical insulation properties. In the covering part, for example, a covering film is formed so as to cover the upper surfaces of the plurality of conductors 5 and base material 6 from above. The covering part may be formed integrally with the insulator film of base material 6, for example. The covering part preferably has an exposure part that exposes connecting part 501 on the conductor side upward. The exposure part may be a single opening through which the plurality of connecting parts 501 on the conductor side are exposed or may be a plurality of openings through which the plurality of connecting parts 501 on the conductor side are exposed individually or in a group of two or more for each opening. The exposure part may include a cutout formed at the front end of the covering part so as to expose (at least one of) the plurality of connecting parts 501 on the conductor side.

Connection target member C11 may further include a reinforcing plate for reinforcing the strength of base material 6. The reinforcing plate is formed using, for example, an insulating resin such as a glass epoxy resin or a metal such as aluminum. The reinforcing plate has, for example, the same shape as coupling region A11. In the reinforcing plate, openings having the same shape (or a slightly larger shape) as first opening 61 and the plurality of second openings 62 are formed at the same positions as the first opening and the plurality of second openings. The reinforcing plate is attached to the lower surface of base material 6 (surface opposite to the upper surface on which conductor 5 is provided) with, for example, an adhesive or the like.

### (1.3) Connector

Next, connector C1 to which connection target member C11 connects will be described with reference to FIGS. 2 - 28.

As illustrated in FIGS. 2 - 4, connector C1 includes a plurality of terminals 10, housing 2, front seal member 30, rear seal member 3, fixing member 4, and slide member 7. For the sake of convenience, illustration of slide member 7 is omitted in the drawings other than FIGS. 1 - 3.

### (1.3.1) Terminal

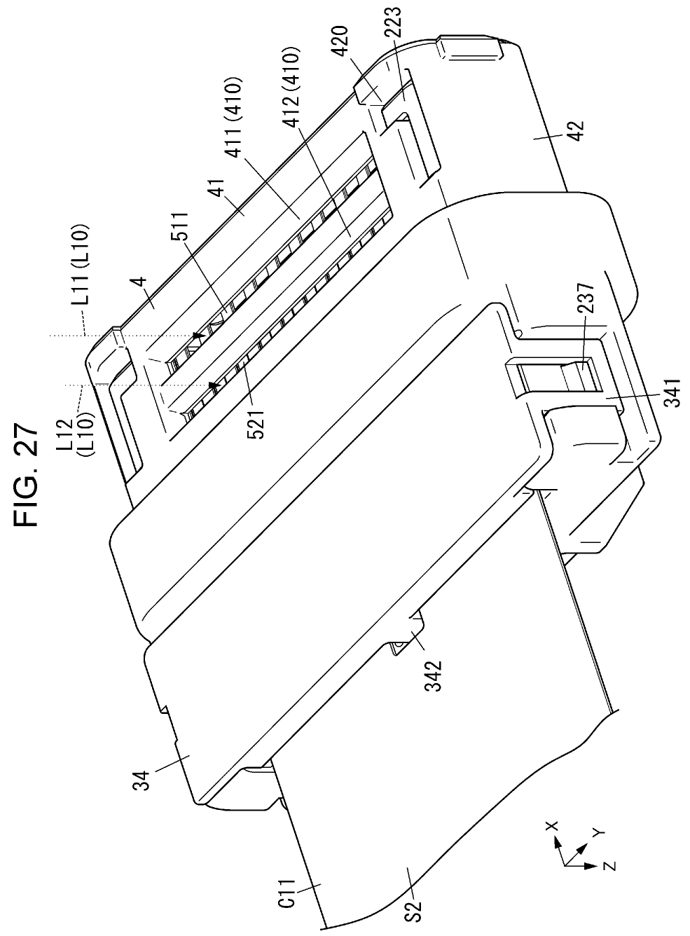

The plurality of terminals 10 respectively connect to the plurality of conductors 5 of connection target member C11. In the present exemplary embodiment, the plurality of terminals 10 respectively connect to the plurality of conductors 5 (see FIG. 6) through laser welding using laser light L10 (see FIG. 27).

As described above, the plurality of terminals 10 respectively connect to the plurality of mating terminals 8 of mating connector C2 in the connected state where connector C1 and mating connector C2 are connected (see FIG. 30).

The plurality of terminals 10 includes at least one first terminal 11 and at least one second terminal 12. Here, the plurality (20) of terminals 10 includes a plurality (10) of first terminals 11 and a plurality (10) of second terminals 12. The plurality of first terminals 11 have the same shape. Each first terminal 11 connects to corresponding first conductor 51 among the plurality of first conductors 51 of connection target member C11. The plurality of second terminals 12 have the same shape. Each second terminal 12 connects to corresponding second conductor 52 among the plurality of second conductors 52 of connection target member C11.

### (1.3.1.1) First terminal

As illustrated in FIGS. 6 - 8, first terminal 11 integrally includes first contact part 111, first connecting part 114, and first coupling part 115.

First contact part 111 is a portion of first terminal 11 that comes into contact with mating terminal 8 of mating connector C2 to connect to mating terminal 8.

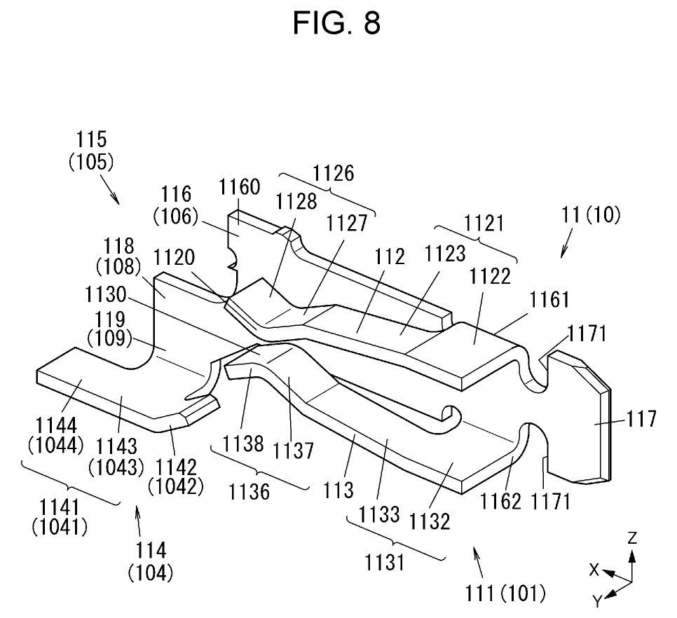

As illustrated in FIG. 8, first contact part 111 includes upper arm 112 and lower arm 113.

Upper arm 112 integrally includes upper arm body 1121 and upper arm contact piece 1126.

Upper arm body 1121 includes flat plate part 1122 and inclined plate part 1123. Flat plate part 1122 has a flat plate shape having a thickness in the up-down direction. The normal direction of flat plate part 1122 is along the up-down direction. Inclined plate part 1123 has a flat plate shape extending obliquely downward from the front end of flat plate part 1122. Inclined plate part 1123 is elastically movable in the up-down direction with respect to flat plate part 1122.

Upper arm contact piece 1126 includes first bent piece 1127 and second bent piece 1128. First bent piece 1127 is bent obliquely downward from the front end of inclined plate part 1123. Second bent piece 1128 is bent obliquely upward from the front end of first bent piece 1127. Upper arm 112 includes upper contact point part 1120 at a coupling portion between first bent piece 1127 and second bent piece 1128.

Lower arm 113 is disposed below upper arm 112. Lower arm 113 integrally includes lower arm body 1131 and lower arm contact piece 1136.

Lower arm body 1131 includes flat plate part 1132 and inclined plate part 1133. Flat plate part 1132 has a flat plate shape having a thickness in the up-down direction. The normal direction of flat plate part 1132 is along the up-down direction. Inclined plate part 1133 has a flat plate shape extending obliquely upward from the front end of flat plate part 1132. Inclined plate part 1133 is elastically movable in the up-down direction with respect to flat plate part 1132.

Lower arm contact piece 1136 includes first bent piece 1137 and second bent piece 1138. First bent piece 1137 is bent obliquely upward from the front end of inclined plate part 1133. Second bent piece 1138 is bent obliquely downward from the front end of first bent piece 1137. Lower arm 113 includes lower contact point part 1130 at a coupling part between first bent piece 1137 and second bent piece 1138.

Upper contact point part 1120 of upper arm 112 and lower contact point part 1130 of lower arm 113 face each other at an interval in the up-down direction. In first terminal 11, the tip portion (first end 81) of mating terminal 8 is sandwiched between upper contact point part 1120 and lower contact point part 1130, whereby first contact part 111 is brought into contact with mating terminal 8. This connects first terminal 11 to mating terminal 8.

First connecting part 114 is a portion of first terminal 11 to be connected to first conductor 51 of connection target member C11. First connecting part 114 is disposed on the front side with respect to first contact part 111 (upper contact point part 1120 and lower contact point part 1130). The front end of first connecting part 114 is positioned on the front side with respect to the front end of first contact part 111. Here, entire first connecting part 114 is positioned on the front side with respect to the front end of first contact part 111.

As illustrated in FIG. 8, first connecting part 114 integrally includes flat part 1141 and guide plate part 1142.

Flat part 1141 has a flat plate shape having a thickness in the up-down direction. Flat part 1141 has a flat lower surface whose normal direction is along the up-down direction. Guide plate part 1142 has a plate-like shape extending upward from the rear end of flat part 1141. Guide plate part 1142 extends obliquely upward and backward from the rear end of flat part 1141.

First coupling part 115 is a portion that couples first contact part 111 and first connecting part 114 in first terminal 11.

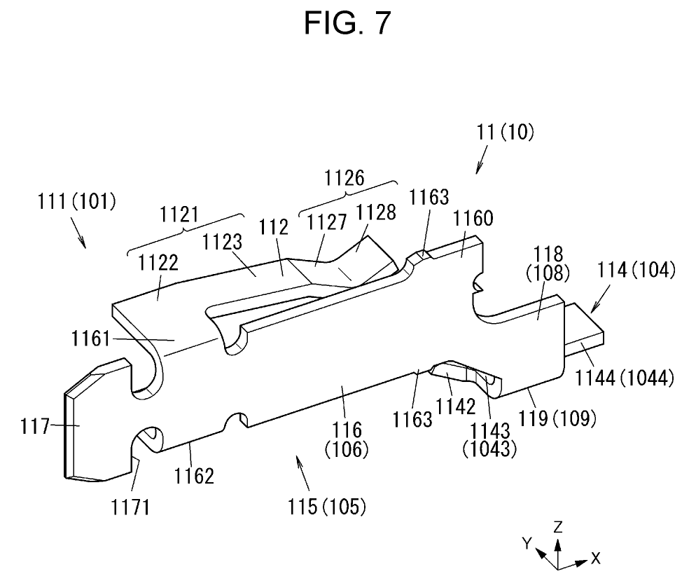

As illustrated in FIGS. 7 and 8, first coupling part 115 integrally includes main body 116, guide plate part 117, leg 118, and curved part 119.

Main body 116 has a plate-like shape having a thickness in the left-right direction and extending in the forward-rearward direction. Main body 116 is coupled to first contact part 111. More specifically, flat plate part 1122 of upper arm 112 of first contact part 111 is coupled to the rear end portion of the upper side surface of main body 116 via upper curved part 1161. Flat plate part 1132 of lower arm 113 of first contact part 111 is coupled to the rear end portion of the lower side surface of main body 116 via lower curved part 1162. First contact part 111 is positioned on the left side of main body 116. As viewed along the left-right direction, upper contact point part 1120 and lower contact point part 1130 of first contact part 111 are covered with main body 116.

Main body 116 has projection part 1160 protruding upward at the front end thereof. Main body 116 has projection part 1163 protruding upward and downward at a position on the rear side with respect to projection part 1160. First terminal 11 is press-fitted into first storage space 2201 by projection part 1163.

Guide plate part 117 has a plate-like shape projecting rearward from the rear end of main body 116. In guide plate part 117, cutouts 1171 are formed on the upper side surface and the lower side surface of a coupling portion with main body 116. Guide plate part 117 guides first terminal 11 (more specifically, first contact part 111) to facilitate insertion of first terminal 11 when first terminal is housed in first storage space 2201 (see FIG. 6) of housing 2. When first terminal 11 is housed in first storage space 2201, guide plate part 117 abuts on the front surface of rear wall 229 of front part 22 of housing 2 constituting first storage space 2201, and thus, it is also possible to prevent first terminal 11 from being excessively pushed into first storage space 2201.

Leg 118 extends downward from the front-end part of main body 116. Leg 118 has a plate-like shape having a thickness in the left-right direction. Leg 118 extends obliquely forward and downward from the front-end part of main body 116.

Curved part 119 is curved leftward from the lower end of leg 118. Curved part 119 couples the lower end of leg 118 and the left side surface of first connecting part 114 (more specifically, flat part 1141).

Here, the front end of flat part 1141 of first connecting part 114 is positioned on the front side with respect to the front end of curved part 119 of first coupling part 115. Thus, it can be said that first connecting part 114 has a coupling connecting part 1143 (rear portion of flat part 1141) coupled to curved part 119 of first coupling part 115 and protrusion 1144 (front portion of flat part 1141) protruding forward from coupling connecting part 1143. Flat part 1141 of first connecting part 114 may have a rear protrusion protruding rearward from coupling connecting part 1143. Rear protrusion has a flat plate shape protruding rearward from the rear end of coupling connecting part 1143. That is, flat part 1141 may have coupling connecting part 1143 coupled to curved part 119 of first coupling part 115, protrusion 1144 protruding forward from the front end of coupling connecting part 1143, and a rear protrusion protruding rearward from the rear end of coupling connecting part 1143. At this time, the length of protrusion 1144 in the forward-rearward direction is preferably larger than the length of the rear protrusion in the forward-rearward direction. Guide plate part 1142 can be formed to be coupled to the rear end of the rear protrusion. Flat part 1141 may have coupling connecting part 1143 and a rear protrusion without having protrusion 1144.

### (1.3.1.2) Second Terminal

As illustrated in FIGS. 6, 9, and 10, second terminal 12 integrally includes second contact part 121, second connecting part 124, and second coupling part 125.

Second contact part 121 is a portion of second terminal 12 that comes into contact with mating terminal 8 of mating connector C2 to connect to mating terminal 8. Second contact part 121 has a bilaterally symmetrical structure with first contact part 111 of first terminal 11.

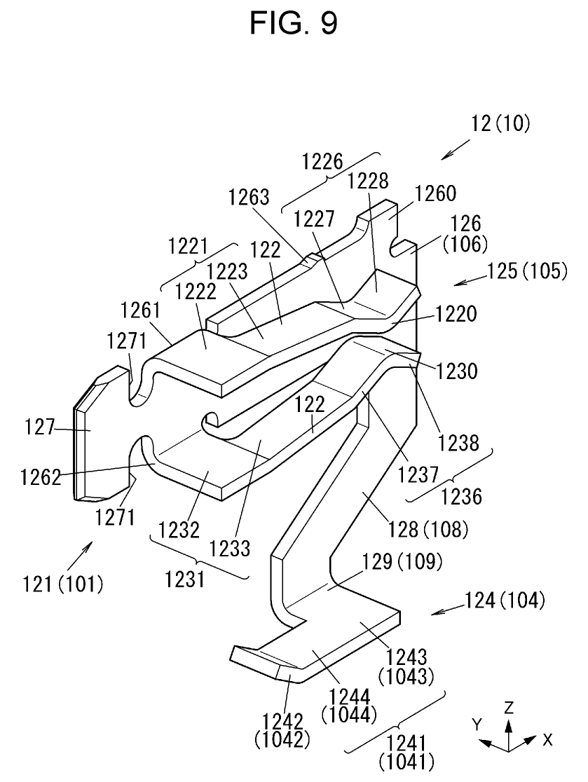

As illustrated in FIG. 9, second contact part 121 includes upper arm 122 and lower arm 123.

Upper arm 122 integrally includes upper arm body 1221 and upper arm contact piece 1226.

Upper arm body 1221 includes flat plate part 1222 and inclined plate part 1223. Flat plate part 1222 has a flat plate shape having a thickness in the up-down direction. The normal direction of flat plate part 1222 is along the up-down direction. Inclined plate part 1223 has a flat plate shape extending obliquely downward from the front end of flat plate part 1222. Inclined plate part 1223 is elastically movable in the up-down direction with respect to flat plate part 1222.

Upper arm contact piece 1226 includes first bent piece 1227 and second bent piece 1228. First bent piece 1227 is bent obliquely downward from the front end of inclined plate part 1223. Second bent piece 1228 is bent obliquely upward from the front end of first bent piece 1227. Upper arm 122 includes upper contact point part 1220 at a coupling portion between first bent piece 1227 and second bent piece 1228.

Lower arm 123 is disposed below upper arm 122. Lower arm 123 integrally includes lower arm body 1231 and lower arm contact piece 1236.

Lower arm body 1231 includes flat plate part 1232 and inclined plate part 1233. Flat plate part 1232 has a flat plate shape having a thickness in the up-down direction. The normal direction of flat plate part 1232 is along the up-down direction. Inclined plate part 1233 has a flat plate shape extending obliquely upward from the front end of flat plate part 1232. Inclined plate part 1233 is elastically movable in the up-down direction with respect to flat plate part 1232.

Lower arm contact piece 1236 includes first bent piece 1237 and second bent piece 1238. First bent piece 1237 is bent obliquely upward from the front end of inclined plate part 1233. Second bent piece 1238 is bent obliquely downward from the front end of first bent piece 1237. Lower arm 123 includes lower contact point part 1230 at a coupling part between first bent piece 1237 and second bent piece 1238.

Upper contact point part 1220 of upper arm 122 and lower contact point part 1230 of lower arm 123 face each other at an interval in the up-down direction. In second terminal 12, the tip portion (first end 81) of mating terminal 8 is sandwiched between upper contact point part 1220 and lower contact point part 1230, whereby second contact part 121 is brought into contact with mating terminal 8. This connects second terminal 12 to mating terminal 8.

=Second connecting part 124 is a portion of second terminal 12 to be connected to second conductor 52 of connection target member C11. In the forward-rearward direction, second connecting part 124 is disposed at the same position as second contact part 121 (upper contact point part 1120 and lower contact point part 1130). The rear end of second connecting part 124 overlaps second contact part 121 in the up-down direction.

As illustrated in FIG. 9, second connecting part 124 integrally includes flat part 1241 and guide plate part 1242.

Flat part 1241 has a flat plate shape having a thickness in the up-down direction. Flat part 1241 has a flat lower surface whose normal direction is along the up-down direction. Guide plate part 1242 has a plate-like shape extending upward from the rear end of flat part 1241. Guide plate part 1242 extends obliquely upward and backward from the rear end of flat part 1241.

Second coupling part 125 is a portion of second terminal 12 coupling second contact part 121 and second connecting part 124.

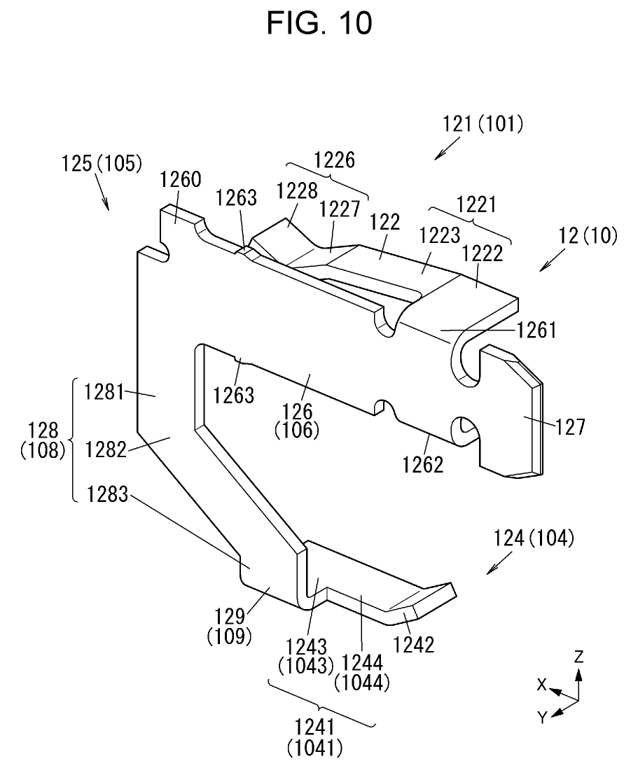

As illustrated in FIGS. 9 and 10, second coupling part 125 integrally includes main body 126, guide plate part 127, leg 128, and curved part 129.

Main body 126 has a plate-like shape having a thickness in the left-right direction and extending in the forward-rearward direction. The main body 126 is coupled to second contact part 121. More specifically, flat plate part 1222 of upper arm 122 of second contact part 121 is coupled to the rear end part of the upper side surface of main body 126 via upper curved part 1261. Flat plate part 1232 of lower arm 123 of second contact part 121 is coupled to the rear end portion of the lower side surface of main body 126 via lower curved part 1262. Second contact part 121 is positioned on the right side of main body 126. As viewed along the left-right direction, upper contact point part 1220 and lower contact point part 1230 of second contact part 121 are covered by main body 126.

Main body 126 has projection part 1260 protruding upward at the front end thereof. Projection part 1260 protrudes upward with respect to the other portion of second terminal 12. Main body 126 has projection part 1263 protruding upward and downward at positions on the rear side with respect to projection part 1260. Second terminal 12 is press-fitted into second storage space 2202 by projection part 1263.

Guide plate part 127 has a plate-like shape projecting rearward from the rear end of main body 126. In guide plate part 127, cutouts 1271 are formed on the upper side surface and the lower side surface of a coupling portion with main body 126. Guide plate part 127 guides second terminal 12 (more specifically, second contact part 121) to facilitate insertion of second terminal 12 when the second terminal is housed in second storage space 2202 (see FIG. 6) of housing 2. When second terminal 12 is housed in second storage space 2202, guide plate part 127 abuts on the front surface of rear wall 229 of front part 22 of housing 2 constituting second storage space 2202, and thus, it is also possible to prevent second terminal 12 from being excessively pushed into second storage space 2202.

Leg 128 extends downward from the front-end part of main body 126. Leg 128 has a plate-like shape having a thickness in the left-right direction. Leg 128 includes first portion 1281 extending downward from the lower end of the front-end part of main body 126, second portion 1282 extending obliquely backward and downward from the lower end of first portion 1281, and third portion 1283 extending downward from the lower end of second portion 1282.

Leg 128 of second coupling part 125 of second terminal 12 is longer than leg 118 of first coupling part 115 of first terminal 11 in the up-down direction. Thus, when first connecting part 114 of first terminal 11 and second connecting part 124 of second terminal 12 are on the same plane, second contact part 121 of second terminal 12 is positioned above first contact part 111 of first terminal 11.

In the forward-rearward direction, the direction (rear side) in which leg 128 of second terminal 12 extends from main body 126 is opposite to the direction (front side) in which leg 118 of first terminal 11 extends from main body 116. Thus, while first contact part of first terminal 11 and second contact part 121 of second terminal 12 are arranged in the up-down direction, first connecting part 114 of first terminal 11 and second connecting part 124 of second terminal 12 can be arranged in the forward-rearward direction, and connector C1 can be downsized.

Curved part 129 is curved rightward from the lower end of leg 128 (lower end of third portion 1283). Curved part 129 couples the lower end of leg 128 and the right-side surface of second connecting part 124 (more specifically, flat part 1241).

Here, the rear end of flat part 1241 of second connecting part 124 is positioned on the rear side with respect to the rear end of curved part 129 of second coupling part 125. Thus, it can be said that second connecting part 124 has coupling connecting part 1243 (front portion of flat part 1241) to be coupled to curved part 129 of second coupling part 125 and protrusion 1244 (rear portion of flat part 1241) protruding rearward from coupling connecting part 1243. In second connecting part 124, guide plate part 1242 extends obliquely upward and rearward from the rear end of protrusion 1244. Flat part 1241 of second connecting part 124 may have a front protrusion protruding forward from coupling connecting part 1243. The front protrusion has a flat plate shape protruding forward from the front end of coupling connecting part 1243. That is, flat part 1241 may have coupling connecting part 1243 to be coupled to curved part 129 of second coupling part 125, protrusion 1244 protruding rearward from the rear end of coupling connecting part 1243, and a front protrusion protruding forward from the front end of coupling connecting part 1243. At this time, the length of protrusion 1244 in the forward-rearward direction is preferably larger than the length of the front protrusion in the forward-rearward direction. Flat part 1241 may have coupling connecting part 1243 and a front protrusion without having protrusion 1244. At this time, guide plate part 1242 can be formed to be coupled to the rear end of coupling connecting part 1243.

### (1.3.1.3) Connection of Connection Target Member to Conductor

As illustrated in FIG. 6, first connecting part 114 (more specifically, the lower surface of flat part 1141) of first terminal 11 is disposed on the upper surface of first connecting part 511 of first conductor 51 of connection target member C11. First connecting part 114 connects to first connecting part 511 through laser welding. Since the lower surface of flat part 1141 to be connected to first conductor 51 by laser welding is flat, connection reliability is improved. In addition, by forming protrusion 1144 (and the rear protrusion), the connection portion can be enlarged, and the reliability of connection is improved.

Second connecting part 124 (more specifically, the lower surface of flat part 1241) of second terminal 12 is disposed on the upper surface of second connecting part 521 of second conductor 52 of connection target member C11. Second connecting part 124 connects to second connecting part 521 through laser welding. Since the lower surface of flat part 1241 to be connected to second conductor 52 by laser welding is flat, connection reliability is improved. In addition, by forming protrusion 1244 (and the front protrusion), the connection portion can be enlarged, and the reliability of connection is improved.

Hereinafter, first contact part 111 of first terminal 11 and second contact part 121 of second terminal 12 may be referred to as “contact parts 101”.

First connecting part 114 of first terminal 11 and second connecting part 124 of second terminal 12 may be referred to as “connecting parts 104”. Flat part 1141 of first terminal 11 and flat part 1241 of second terminal 12 may be referred to as “flat parts 1041”. Guide plate part 1142 of first terminal 11 and guide plate part 1242 of second terminal 12 may be referred to as "guide plate parts 1042". Coupling connecting part 1143 of first terminal 11 and coupling connecting part 1243 of second terminal 12 may be referred to as "coupling connecting parts 1043". Protrusion 1144 of first terminal 11 and protrusion 1244 of second terminal 12 may be referred to as "protrusions 1044".

First coupling part 115 of first terminal 11 and second coupling part 125 of second terminal 12 may be referred to as “coupling parts 105”. Main body 116 of first terminal 11 and main body 126 of second terminal 12 may be referred to as “main bodies 106”. Leg 118 of first terminal 11 and leg 128 of second terminal 12 may be referred to as "legs 108". Curved part 119 of first terminal 11 and curved part 129 of second terminal 12 may be referred to as "curved parts 109".

### (1.3.2) Housing

Housing 2 holds a plurality of terminals 10. Housing 2 is formed using, for example, an electrically insulating resin material.

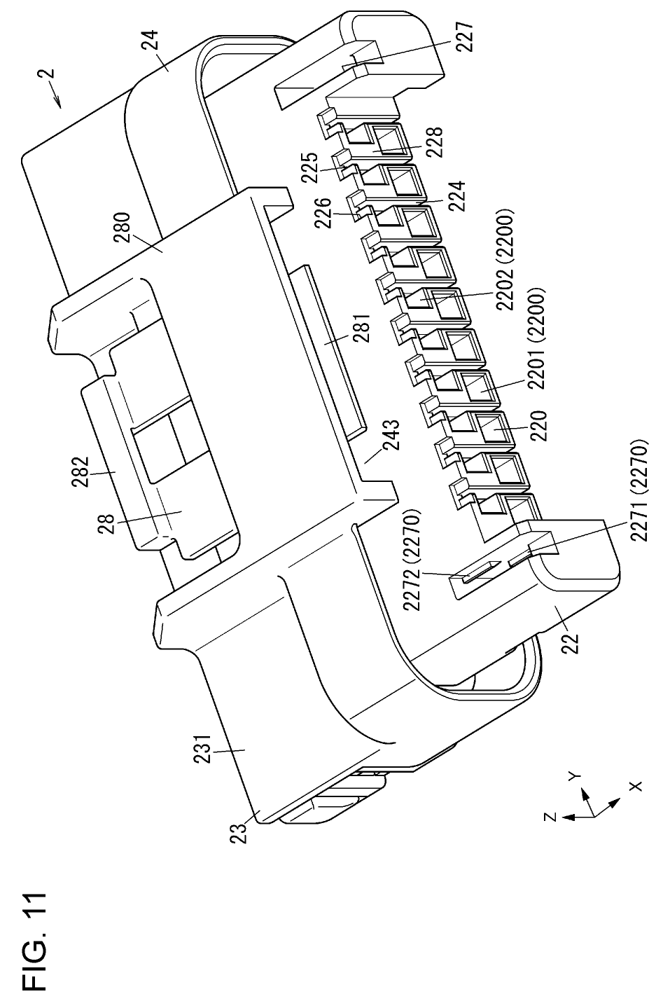

As illustrated in FIGS. 11 - 14, housing 2 integrally includes main body 21, front part 22, rear part 23, and skirt 24.

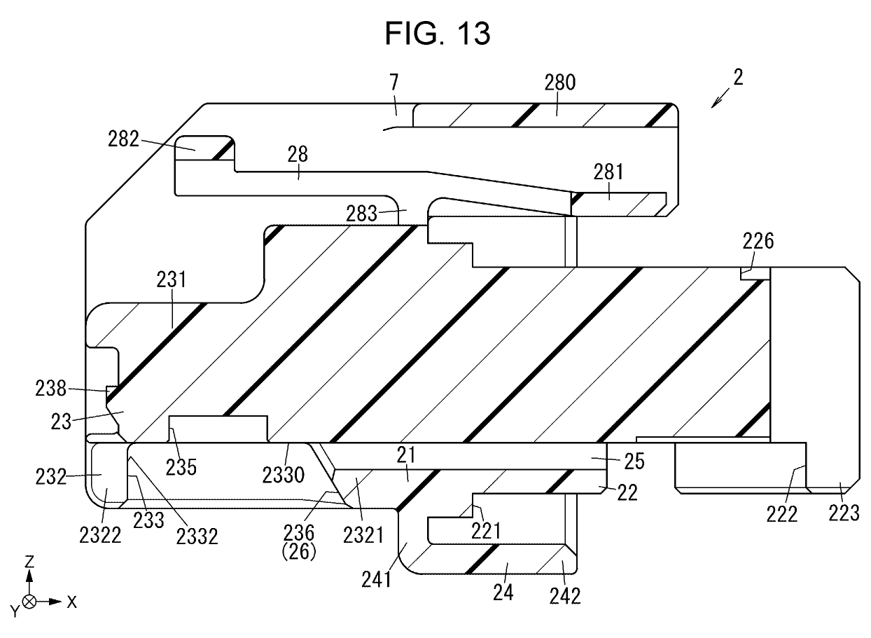

As illustrated in FIG. 13, main body 21 is a central portion of housing 2 in the forward-rearward direction. Main body 21 has a substantially rectangular parallelepiped shape elongated in the left-right direction.

As illustrated in FIGS. 11 - 14, front part 22 is a front part of housing 2 that comes to mating connector C2 side when connector C1 and mating connector C2 connect to each other (see FIG. 2). Front part 22 has a substantially rectangular parallelepiped shape elongated in the left-right direction. Front part 22 protrudes forward from main body 21. Front part 22 is coupled to the front end of main body 21. Front part 22 is, for example, a portion of housing 2 that is housed in mating recess 90 of mating connector C2 in a connected state (see FIG. 30) in which connector C1 and mating connector C2 are connected.

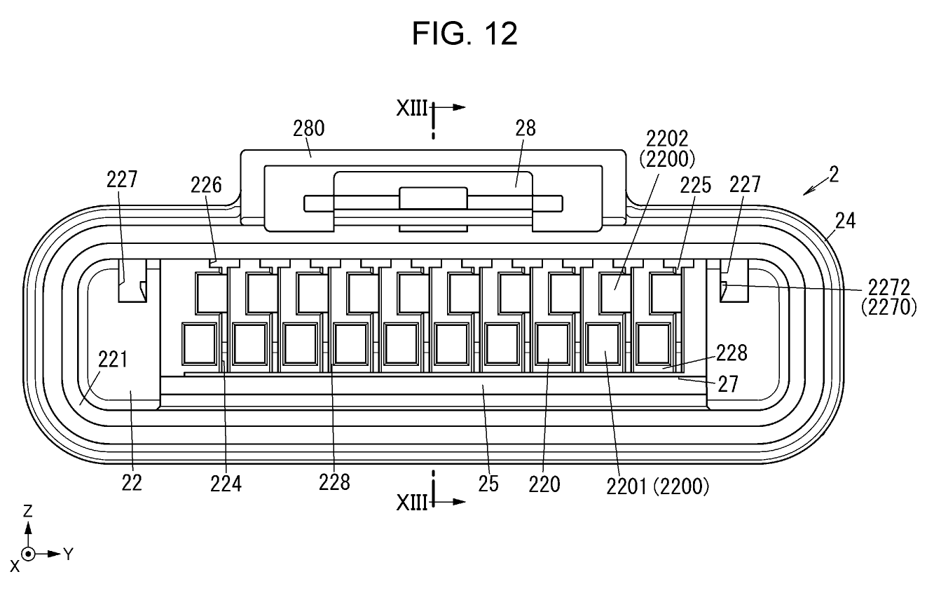

As illustrated in FIGS. 12 and 13, step 221 is formed circumferentially in a rear portion of front part 22. As illustrated in FIG. 13, a dimension in the up-down direction of a portion on the front side with respect to step 221 in front part 22 is smaller than a dimension in the up-down direction of main body 21. In front part 22, the dimension in the left-right direction of the portion on the front side with respect to step 221 is smaller than the dimension in the left-right direction of main body 21.

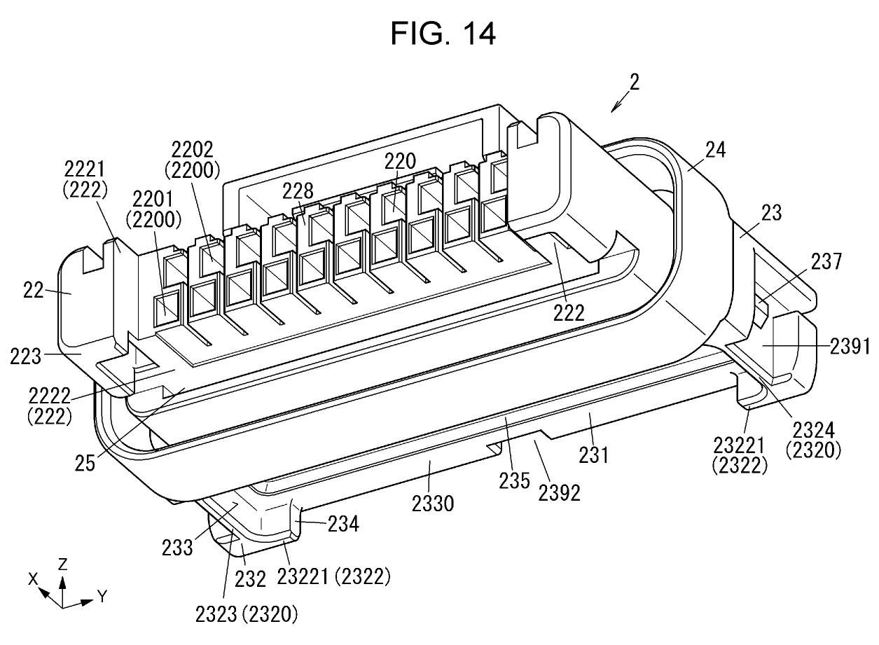

As illustrated in FIG. 14, disposition recess 222 for disposing fixing member 4 is formed in front part 22. Disposition recess 222 includes first recess 2221 and second recess 2222.

On the lower surface of front part 22, two positioning projections 223 having an L-shape in a bottom view and protruding downward are provided on a peripheral edge of disposition recess 222 (second recess 2222). Disposition recess 222 (second recess 2222) is formed to be separated by positioning projection 223.

More specifically, first recess 2221 is formed so as to cut out the front-end portion of front part 22 and is open so as to penetrate the front-end portion of front part 22 in the up-down direction at the center in the left-right direction.

Second recess 2222 is connected to first recess 2221 in the forward-rearward direction. Second recess 2222 is formed so as to cut out the lower surface side of front part 22 in a rectangular shape. Between positioning projections 223 on both sides in the left-right direction, second recess 2222 has a front portion formed so as to open the lower surface side of front part 22 downward in a rectangular shape, and a rear portion formed on the rear side with respect to positioning projections 223 on both sides so as to penetrate the lower surface side of front part 22 in the left-right direction.

The front end of lower cover 41 (described later) of fixing member 4 is disposed between positioning projections 223 of first recess 2221. The rear side of lower cover 41 of fixing member 4 with respect to the front side is disposed to face the bottom surface of second recess 2222 (lower surface of front part 22).

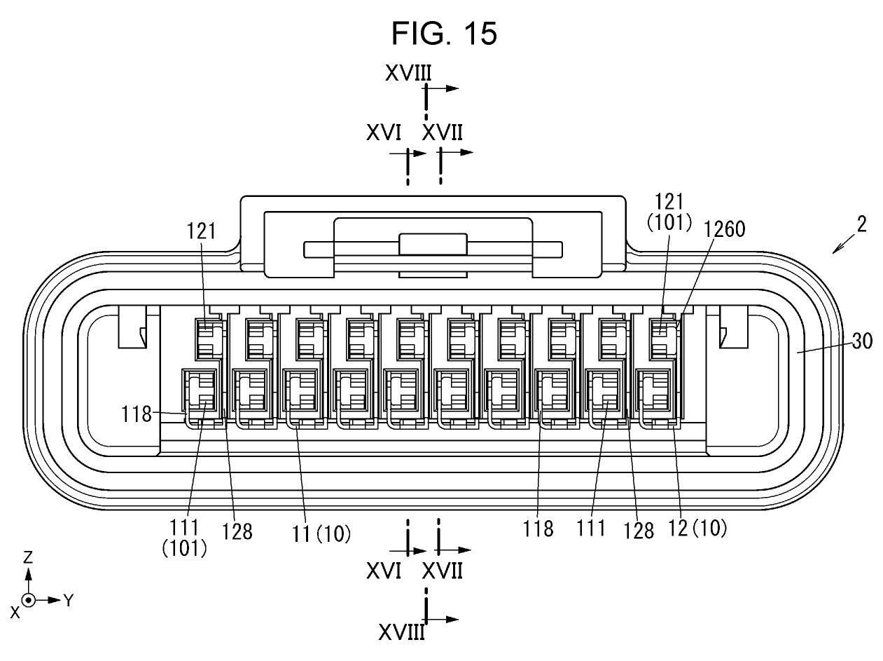

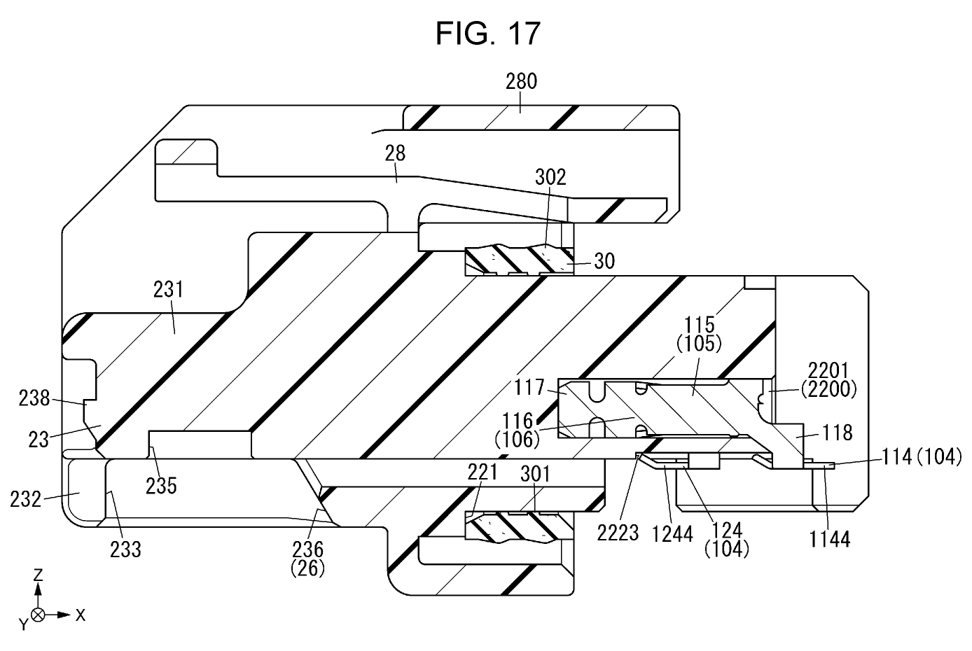

Here, as illustrated in FIGS. 15 and 17, connecting part 104 between first terminal 11 and second terminal 12 is disposed in disposition recess 222. Connecting part 104 is disposed below and away from the bottom surface of disposition recess 222 (lower surface of front part 22) as viewed along the forward-rearward direction. In disposition recess 222, stepped part 2223 (see FIG. 17) is formed so as to be recessed upward so that the tip of guide plate part 1042 (see FIG. 6) of connecting part 104 can be disposed. This allows guide plate part 1042 to reliably guide the insertion of connection target member C11.

A plurality of terminals 10 are disposed in front part 22 (see FIGS. 15 - 18). More specifically, as illustrated in FIGS. 11, 12, and 14, front part 22 has storage part 220 recessed rearward from the front surface of front part 22. At least contact part 101 of each of the plurality of terminals 10 is stored in storage part 220.

Here, storage part 220 includes a plurality of storage spaces 2200. Contact parts 101 of the plurality of terminals 10 are respectively housed in the plurality of storage spaces 2200. Here, the number of storage spaces 2200 is the same as the number of terminals 10, and it is 20. Then, one contact part 101 of one terminal 10 is housed in each storage space 2200.

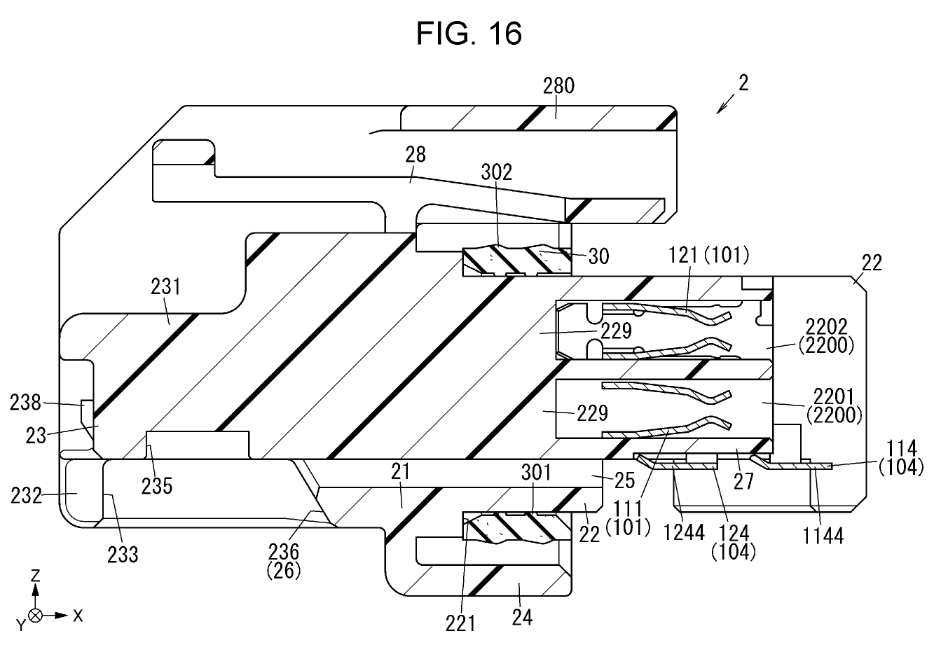

Each storage space 2200 is a recess recessed rearward in a rectangular parallelepiped shape from the front surface of front part 22. In other words, each storage space 2200 is formed by peripheral wall 228 that is open forward and surrounds storage space 2200 and the rear wall 229 (see FIG. 16) that is coupled to peripheral wall 228 and closes the rear side of storage space 2200. Peripheral wall 228 includes an upper wall, a lower wall, a right wall, and a left wall.

Storage spaces 2200 thus house contact part 101 of at least one terminal 10 among the plurality of terminals 10. Since terminal 10 (contact part 101) is housed in storage space 2200, terminal 10 (and mating terminal 8 in contact with terminal 10) can be protected by peripheral wall 228 of storage space 2200.

The plurality of storage spaces 2200 includes at least one first storage space 2201 and at least one second storage space 2202. Here, the plurality (20) of storage spaces 2200 includes a plurality (10) of first storage spaces 2201 and a plurality (10) of second storage spaces 2202.

First storage space 2201 is formed in a lower portion of front part 22 of housing 2. The plurality of first storage spaces 2201 is provided side by side at equal intervals in the width direction (left-right direction) of front part 22.

Second storage space 2202 is formed in an upper portion of front part 22 of housing 2. The plurality of second storage spaces 2202 are provided side by side at equal intervals in the width direction (left-right direction) of front part 22.

In storage part 220, one first storage space 2201 and one second storage space 2202 are arranged in the up-down direction. The lower surface of the lower wall of peripheral wall 228 in the first storage space 2201 is the lower surface of front part 22. The upper wall of peripheral wall 228 in first storage space 2201 is also used as the lower wall of peripheral wall 228 in second storage space 2202 and serves as a partition wall between first storage space 2201 and second storage space 2202. The upper surface of the upper wall of peripheral wall 228 in second storage space 2202 is the upper surface of front part 22.

As illustrated in FIG. 16, first storage space 2201 houses first contact part 111 of first terminal 11. Second storage space 2202 houses second contact part 121 of second terminal 12. In a state where first contact part 111 of first terminal 11 and second contact part 121 of second terminal 12 are respectively housed in first storage space 2201 and second storage space 2202 arranged in the up-down direction, first contact part 111 and second contact part 121 are arranged in the up-down direction. In a state where first contact part 111 of first terminal 11 and second contact part 121 of second terminal 12 are respectively housed in first storage space 2201 and second storage space 2202 arranged in the up-down direction, first connecting part 114 of first terminal 11 and second connecting part 124 of second terminal 12 are at the same position (height) in the up-down direction and are arranged in the forward-rearward direction.

First terminal 11 and second terminal 12 are disposed in housing 2 by being inserted along the forward-rearward direction from the opening in front of first storage space 2201 and second storage space 2202, respectively.

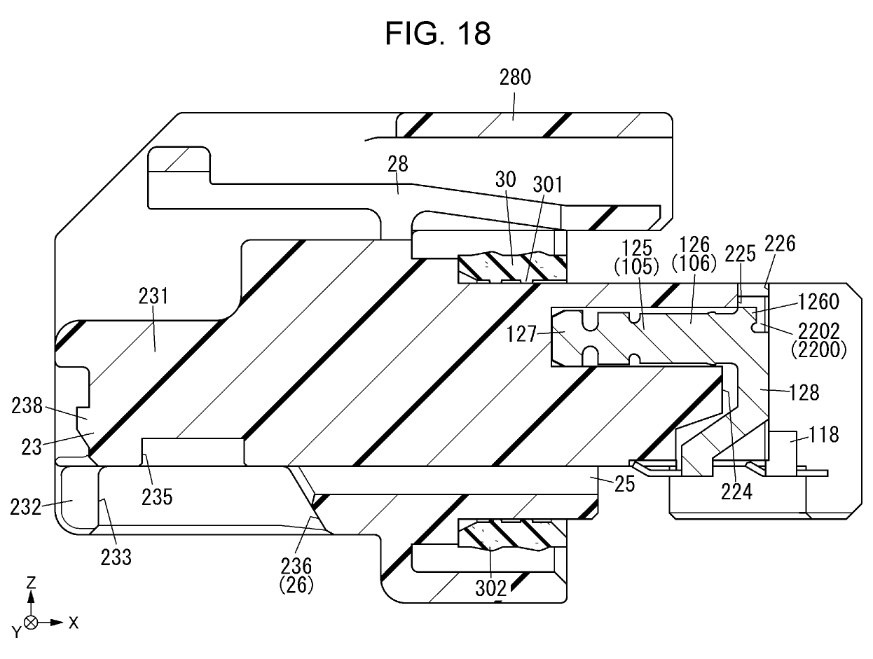

As illustrated in FIG. 17, first storage space 2201 also houses main body 116 of first coupling part 115 of first terminal 11. As illustrated in FIG. 18, second storage space 2202 also houses main body 126 of second coupling part 125 of second terminal 12. Main body 106 of coupling part 105 of terminal 10 is thus also housed in storage space 2200.

Protrusion 1144 of first connecting part 114 of first terminal 11 protrudes forward with respect to front part 22 of housing 2. On the other hand, protrusion 1244 of second connecting part 124 of second terminal 12 protrudes rearward from coupling connecting part 1243 so as to overlap front part 22 of housing 2 as viewed along the up-down direction. This allows first connecting part 114 of first terminal 11 and second connecting part 124 of second terminal 12 to be arranged side by side in the forward-rearward direction, and connector C1 can be downsized.

As illustrated in FIG. 12, first groove 224 extending in the up-down direction is formed in the left wall of peripheral wall 228 forming first storage space 2201 from the upper wall to the lower wall. The upper end of first groove 224 is released to the upper surface of the lower wall of peripheral wall 228 of second storage space 2202. The lower end of first groove 224 is released to the lower surface of the lower wall of peripheral wall 228 of first storage space 2201. First groove 224 communicates in the up-down direction from the upper end to the lower end of first groove 224.

As illustrated in FIGS. 15 and 18, leg 128 of second terminal 12 in which second contact part 121 is housed in second storage space 2202 above first storage space 2201 is disposed in first groove 224.

As illustrated in FIG. 12, second groove 225 extending in the up-down direction is formed in the upper wall of peripheral wall 228 forming second storage space 2202. The upper end of second groove 225 is released to the upper surface (that is, the upper surface of front part 22) of the upper wall of peripheral wall 228 of second storage space 2202. The lower end of second groove 225 is released to the lower surface of the upper wall of peripheral wall 228 of second storage space 2202. Second groove 225 communicates in the up-down direction from the upper end of second groove 225 to the lower end of first groove 224 via second storage space 2202.

As illustrated in FIGS. 15 and 18, projection part 1260 of main body 126 of second coupling part 125 of second terminal 12 in which second contact part 121 is housed in second storage space 2202 is disposed in second groove 225.

As illustrated in FIG. 12, on the upper surface of front part 22 of housing 2, recess 226 is formed on the upper side of second groove 225. The upper end of second groove 225 is connected to the bottom surface of recess 226. As a result, as illustrated in FIG. 18, the upper end of projection part 1260 of main body 126 of second coupling part 125 disposed in second groove 225 is exposed upward.

As illustrated in FIGS. 11 and 12, at least one opening part 227 is formed in front part 22. Here, a pair of opening parts 227 is formed on both left and right sides of storage part 220 in front part 22. Here, opening part 227 penetrates front part 22 in the up-down direction. Fixing member 4 (projecting wall part 44 described later) is disposed in opening part 227.

Projection 2270 is formed on an inner side surface of opening part 227 in the left-right direction. Here, two projections 2270 are formed on the inner side surface of opening part 227 in the left-right direction.

Two projections 2270 are formed at different positions in the up-down direction. That is, two projections 2270 are formed at different positions as viewed along the forward-rearward direction.

Two projections 2270 are formed at different positions in the forward-rearward direction. Two projections 2270 are formed so as not to overlap each other in the forward-rearward direction.

The rear end part of one projection of two projections 2270 in front of the other projection and the front-end part of the other projection of projections 2270 may be formed to be flush with or overlap with each other as viewed along the up-down direction.

Hereinafter, lower projection 2270 of two projections 2270 is also referred to as "first projection 2271", and upper projection 2270 is also referred to as "second projection 2272". The front-end part of first projection 2271 is positioned on the front side with respect to the front-end part of second projection 2272. That is, first projection 2271 formed on the lower side is positioned on the front side with respect to second projection 2272 formed on the upper side.

As illustrated in FIGS. 11 and 13, rear part 23 is a portion of housing 2 on the rear side opposite to mating connector C2 with respect to front part 22 in the forward-rearward direction (see FIG. 2). Rear part 23 protrudes rearward from main body 21.

As illustrated in FIGS. 13, 14, and 19, rear part 23 includes rear part body 231 and wall part 232.

Rear part body 231 has a substantially rectangular parallelepiped shape elongated in the left-right direction.

Rear part body 231 protrudes rearward from the central portion in the up-down direction of main body 21. Wall part 232 has a peripheral wall shape protruding downward from an outer peripheral portion of the lower surface of rear part body 231. Insertion recess 233 recessed upward is formed in rear part 23 so as to be surrounded by the lower surface of rear part body 231 and the inner side surface of wall part 232.

As illustrated in FIGS. 13 and 14, wall part 232 includes front wall 2321, rear wall 2322, right wall 2323, and left wall 2324.

Front wall 2321 is formed along the front end of the lower surface of rear part body 231. A front portion of front wall 2321 is formed integrally with a rear portion of main body 21.

Rear wall 2322 is formed along the rear end of the lower surface of rear part body 231. Rear wall 2322 has a pair of partial walls 23221 (see FIG. 14) extending in the left- right direction from respective rear portions of right wall 2323 and left wall 2324 so as to face each other.

Rear wall 2322 is formed with recessed rear end recess 234 separated by a pair of partial walls 23221. The dimension between the inner side surfaces of rear end recess 234 in the left-right direction is larger than the dimension (width dimension) of connection target member C11 in the left-right direction.

Right wall 2323 is formed along the right end of the lower surface of rear part body 231. Right wall 2323 connects right ends of front wall 2321 and rear wall 2322. Left wall 2324 is formed along the left end of the lower surface of rear part body 231. Left wall 2324 connects left ends of front wall 2321 and rear wall 2322.

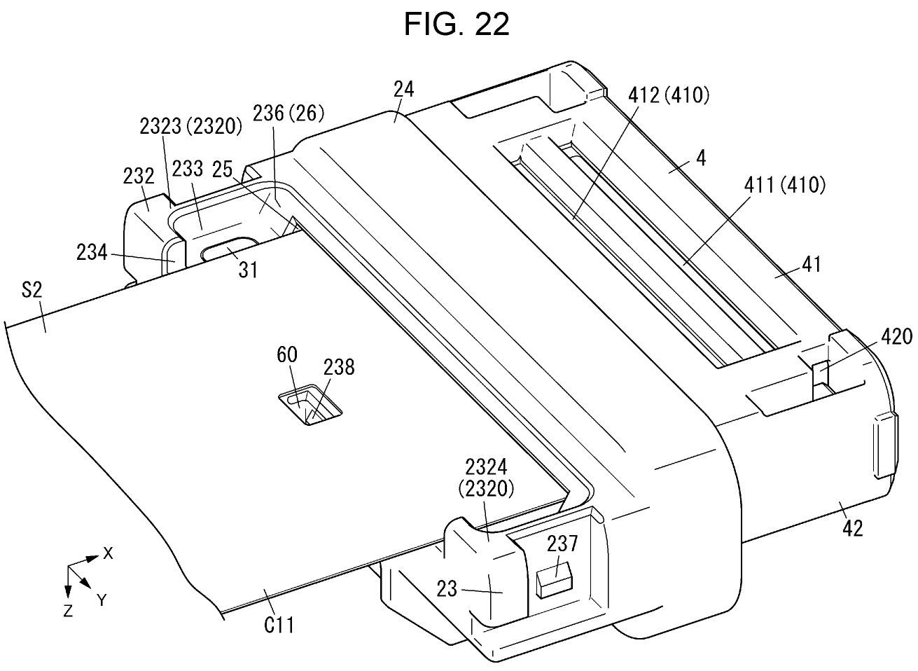

The dimension between the inner side surfaces of insertion recess 233 in the left-right direction is larger than the dimension of connection target member C11 in the left-right direction. Connection target member C11 can be disposed in insertion recess 233 by inserting connection target member C11 from the rear side through rear end recess 234 formed in rear wall 2322 (see FIG. 22). Thus, the lower surface of rear part body 231 (bottom surface of insertion recess 233) is facing surface 2330 that faces connection target member C11 in the up-down direction. In addition, it can be said that rear part 23 has a pair of projecting walls 2320 (right wall 2323 and left wall 2324 of wall part 232) protruding downward from the peripheral edge of facing surface 2330.

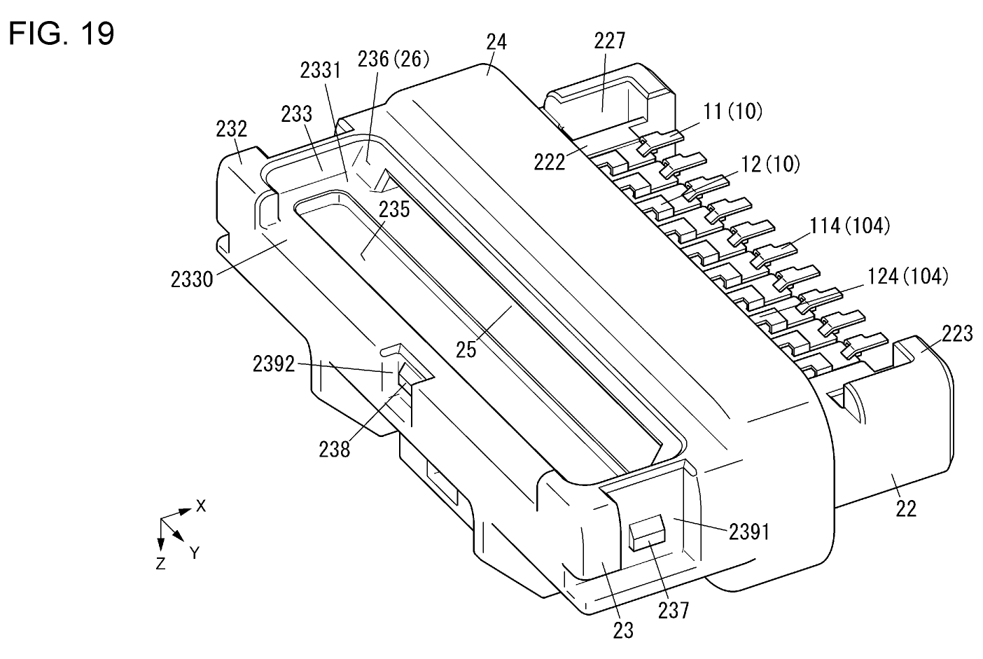

As illustrated in FIGS. 4 and 19, recess 235 recessed upward is formed on the lower surface of rear part 23 (bottom surface of insertion recess 233). Facing surface 2330 of rear part 23 has recess 235 in this manner. Recess 235 is formed to be long in the left-right direction. Here, the dimension of recess 235 in the left-right direction is larger than the dimension of connection target member C11 in the left-right direction.

As illustrated in FIGS. 13 and 19, the rear surface of front wall 2321 of wall part 232 is inclined surface 236 inclined upward and obliquely rearward. In this manner, the inner side surface of insertion recess 233 includes inclined surface 236 inclined such that insertion recess 233 becomes narrower toward the bottom of insertion recess 233. Right wall 2323, left wall 2324, and rear wall 2322 of wall part 232 may also have inclined surfaces.

As illustrated in FIGS. 14 and 19, each of the left and right outer side surfaces of rear part 23 is provided with first recess 2391 recessed upward from the lower end and first projection part 237 (first engaged part) disposed in first recess 2391. The rear surface of rear part body 231 of rear part 23 is provided with second recess 2392 recessed upward from the lower end and second projection part 238 (second engaged part) disposed in second recess 2392.

As illustrated in FIGS. 12, 13, and 19, through hole 25 penetrating housing 2 in the forward-rearward direction is formed in housing 2. Through hole 25 is a flat hole having a rectangular shape in a front view as viewed along the forward-rearward direction.

Through hole 25 penetrates front part 22, main body 21, and front wall 2321 (rear part 23) of wall part 232.

The inner side surface (upper side surface) of through hole 25 is flush with facing surface 2330 of rear part 23. The opening on the rear side of through hole 25 is open to the rear surface of front wall 2321 (rear part 23) of wall part 232. Since the rear surface of front wall 2321 of wall part 232 is inclined surface 236 as described above, it can be said that housing 2 has inclined surface 26 inclined obliquely around the rear opening in through hole 25.

Through hole 25 has a dimension in the left-right direction larger than the dimension in the up-down direction. The dimension of through hole 25 in the left-right direction is larger than the dimension of connection target member C11 in the left-right direction. Connection target member C11 inserted into insertion recess 233 from the rear is inserted into and disposed in through hole 25 from the rear. As described above, in through hole 25, because the dimension in the left-right direction is larger than the dimension in the up-down direction, the plurality of conductors 5 of plate-like connection target member C11 can be easily disposed so as to correspond to connecting parts 104 of the plurality of terminals 10.

As illustrated in FIGS. 12 and 16, through hole 25 is formed in a portion of front part 22 below storage part 220 in housing 2. Through hole 25 is formed below storage space 2200 in housing 2 like this. Through hole 25 is formed in housing 2 so as to overlap with storage space 2200 in the up-down direction.

As illustrated in FIG. 6, the tip of connection target member C11 inserted into through hole 25 from the rear is positioned below front part 22 (in second recess 2222 of disposition recess 222).

As described above, contact part 101 of terminal 10 is housed in the storage space 2200, and connection target member C11 is disposed in through hole 25. Thus, housing 2 has partition wall 27 (lower wall of peripheral wall 228) between connection target member C11 disposed in through hole 25 and the plurality of terminals 10 housed in the plurality of storage spaces 2200 (see FIG. 6). In other words, peripheral wall 228 includes (at least a part of) partition wall 27. Partition wall 27 is positioned between the plurality of contact parts 101 of the plurality of terminals 10 and connection target member C11. Partition wall 27 is preferably positioned between a portion of the plurality of contact parts 101 of the plurality of terminals 10 that is in contact with mating terminal 8 and connection target member C11. Through hole 25 is aligned with storage space 2200 in the up-down direction with partition wall 27 interposed therebetween.

As illustrated in FIG. 13, skirt 24 is coupled to the front end of main body 21 to which main body 21 and front part 22 are coupled and is integrally formed on the outer side surface of the front end of main body 21. Skirt 24 is formed in a cylindrical shape having a substantially rectangular shape in front view so as to surround step 221 of front part 22 from the top, bottom, left, and right.

As illustrated in FIG. 13, skirt 24 integrally includes flange 241 extending outward from the outer side surface of the front end of main body 21 and cylindrical part 242 extending forward from the tip of flange 241. As illustrated in FIGS. 11, 12, and 13 a cutout is formed in a central portion in the left-right direction at the front end of the upper wall (upper wall of housing 2) of skirt 24. Cutout 243 is formed by cutting out the front end of skirt 24 so as to vertically penetrate the skirt.

As illustrated in FIGS. 11 - 13, housing 2 further integrally includes lock part 28 and roof part 280.

Lock part 28 is a member for holding housing 2 of connector C1 and mating housing 9 of mating connector C2 in a fitted state or releasing the fitted state. Lock part 28 is formed on the upper wall of housing 2.

As illustrated in FIGS. 11 and 13, lock part 28 includes engagement part 281, operation part 282, and swing support part 283.

Engagement part 281 has a plate-like shape having a U shape in top view and including a right frame and a left frame extending forward from operation part 282, and a front frame connecting front ends of the right frame and the left frame. Operation part 282 connects the rear ends of the right frame and the left frame of engagement part 281. Swing support part 283 connects the lower surfaces of the right frame and the left frame of engagement part 281 and the upper surface portion of main body 21 of housing 2. Swing support part 283 supports engagement part 281 so that engagement part 281 is swingable up and down. The front frame of engagement part 281 is swingable up and down in cutout 243 of skirt 24.

In lock part 28, lock projection 92 (locked part; see FIG. 2) of mating housing 9 is disposed in a space having a rectangular shape in top view formed by engagement part 281 and operation part 282, and thus, housing 2 and mating housing 9 can be held in a fitted state (see FIG. 30).

Roof part 280 is formed so as to cover lock part 28 (more specifically, lock projection 92 of mating housing 9, which is locked to lock part 28) from above. Roof part 280 is disposed above cutout 243 of skirt 24 in the up-down direction. Roof part 280 is provided so as to bridge between the ends of cutout 243 of skirt 24. Since housing 2 has roof part 280, a situation in which the locked part (lock projection 92) is unintentionally detached from lock part 28 can be suppressed.

As illustrated in FIGS. 1 to 3, slide member 7 is engaged with lock part 28 so as to be slidable in the forward-rearward direction. Slide member 7 integrally includes central frame part 70 extending in the forward-rearward direction, a pair of side frame parts 71 disposed on the left and right sides of central frame part 70 and extending in the forward-rearward direction and coupling part 72 coupling rear ends of central frame part 70 and the pair of side frame parts 71. Engagement grooves extending in the forward-rearward direction are formed on inner surfaces of the pair of side frame parts 71. Engagement ribs formed on the left and right-side walls of engagement part 281 of lock part 28 are fitted into these engagement grooves, which allows slide member 7 to be slidable in the forward-rearward direction with respect to lock part 28. Projecting rib 701 protruding downward is formed at the front end of central frame part 70. In a state where lock part 28 is engaged with lock projection 92, projecting rib 701 is caught on the front-end surface of the front frame of engagement part 281 of lock part 28. This can further suppress a situation in which the locked part (lock projection 92) is unintentionally detached from lock part 28.

### (1.3.3) Seal member

As illustrated in FIGS. 3 and 4, connector C1 includes front seal member 30 and rear seal member 3.

Front seal member 30 is made of an elastic resin such as rubber, for example. Front seal member 30 is formed in a rectangular annular shape as viewed from the front.

Inner projection part 301 is circumferentially provided on the inner peripheral surface of front seal member 30. At least one or more (here, two) inner projection parts 301 are provided on the inner peripheral surface of front seal member 30.

Outer projection part 302 is circumferentially provided on an outer peripheral surface of front seal member 30. At least one or more (here, two) outer projection parts 302 are provided on the outer peripheral surface of front seal member 30.

As illustrated in FIGS. 16 -18, front seal member 30 is disposed along the outer periphery of front part 22. Front seal member 30 is disposed in front of step 221 formed behind front part 22. Two inner projection parts 301 of front seal member 30 are in circumferential contact with the outer peripheral surface of front part 22. As illustrated in FIGS. 3 and 6, through hole 25 is circumferentially surrounded by front seal member 30.

Rear seal member 3 is attached to rear part 23 of housing 2.

As illustrated in FIGS. 3 and 4, rear seal member 3 includes first seal member 31 and second seal member 32 formed separately from first seal member 31.

First seal member 31 is made of resin having elasticity, and is, for example, a silicon-based gel-like member.

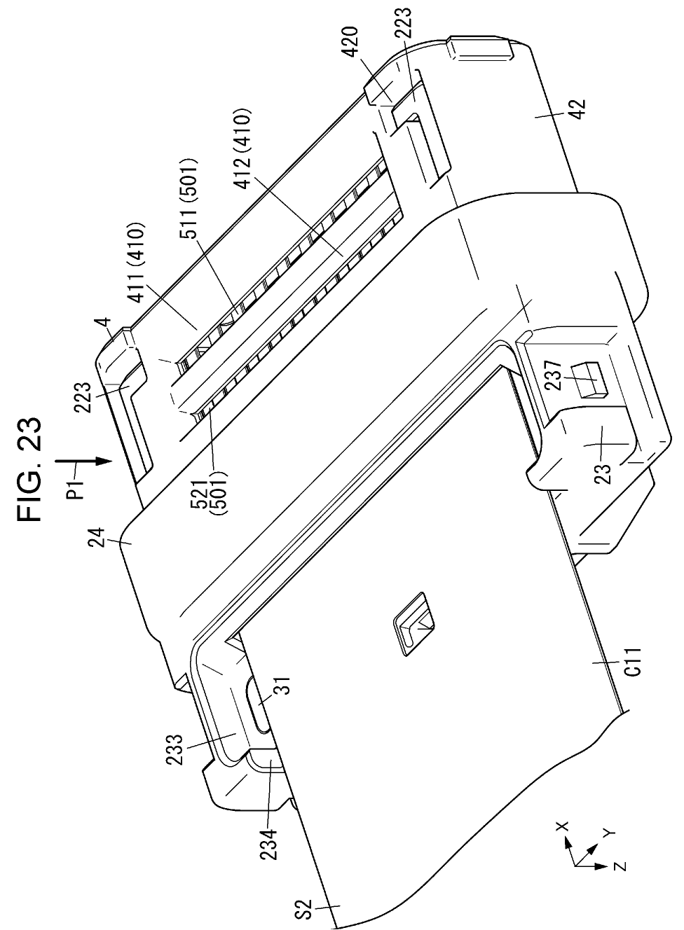

First seal member 31 is formed in a plate-like shape elongated in the left-right direction. First seal member 31 is disposed in recess 235 of facing surface 2330 of rear part 23. First seal member 31 is disposed between facing surface 2330 (bottom surface of recess 235) of rear part 23 and connection target member C11 in the up-down direction. As illustrated in FIG. 23, the dimension of first seal member 31 in the left-right direction is larger than the dimension of connection target member C11 in the left-right direction.

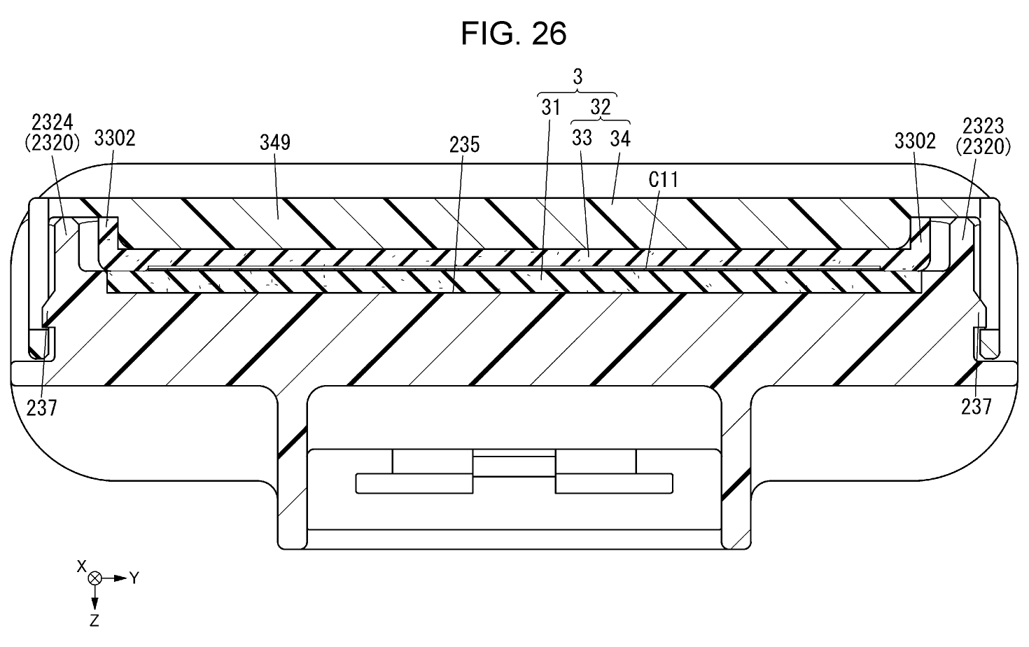

Second seal member 32 is attached to rear part 23 of housing 2. Second seal member 32 is disposed so as to sandwich connection target member C11 between first seal member 31 and second seal member 32 in the up-down direction. First seal member 31 and second seal member 32 abut on each other on both sides in the left-right direction with connection target member C11 interposed therebetween. This allows rear seal member 3 to come into contact with connection target member C11 so as to be in circumferential close contact with connection target member C11, as illustrated in FIG. 26. This can improve the sealing properties (waterproof properties and dust-proof properties) of the surface of connection target member C11 in the forward-rearward direction.

Second seal member 32 is disposed in a region surrounded by the pair of projecting walls 2320 and facing surface 2330. As a result, second seal member 32 can be easily disposed in rear part 23, and the sealing properties can improve.

As illustrated in FIGS. 3 and 4, second seal member 32 includes elastic member 33 and pressing member 34.

Elastic member 33 is made of resin having elasticity, and is, for example, a silicon-based gel-like member. Elastic member 33 has a tray shape elongated in the left-right direction and has recess 330 recessed upward on the lower surface thereof. Elastic member 33 has a shape that fits into insertion recess 233 of rear part 23.

Elastic member 33 is disposed in contact with and sandwiched between connection target member C11 and pressing member 34 in the up-down direction.

It is desirable to form an adhesive layer between elastic member 33 and pressing member 34. For example, the adhesive layer can be formed on the surface of recess 330 of elastic member 33.

Elastic member 33 includes front end wall 3301 formed at a front end part and protruding downward, a pair of side walls 3302 coupled to both end parts of front end wall 3301 in the left-right direction and protruding downward, and rear end opening part 3303 that is open rearward at rear ends of the pair of side walls 3302.

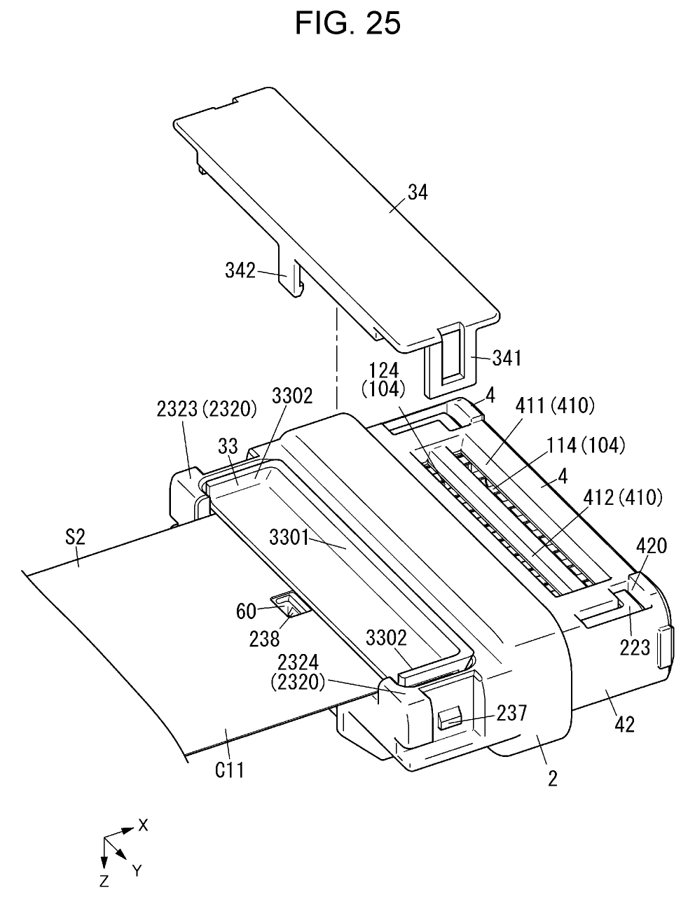

As illustrated in FIGS. 25 and 26, a gap is formed between the pair of side walls 3302 and the inner side surfaces of the pair of projecting walls 2320 of wall part 232 in rear part 23 of housing 2. As a result, elastic member 33 can be easily disposed in insertion recess 233.

On the outer side surfaces of the pair of side walls 3302 of elastic member 33, projections extending long in the forward-rearward direction may be formed. In this case, the protruding projection can be disposed so as to be in contact with the inner side surface of projecting wall 2320 of wall part 232.

First seal member 31 and elastic member 33 abut on each other on both sides in the left-right direction with connection target member C11 interposed therebetween (see FIG. 26).

Pressing member 34 is a member for attaching elastic member 33 to rear part 23. Pressing member 34 is made of, for example, resin. Pressing member 34 has a hardness higher than that of elastic member 33. In other words, elastic member 33 has a hardness smaller than that of pressing member 34. The hardness referred to herein is, for example, Rockwell hardness (for example, scale A). For example, pressing member 34 is attached to rear part 23 so as to press elastic member 33 against connection target member C11.

As illustrated in FIGS. 3 and 4, pressing member 34 integrally includes plate-like main body 349 elongated in the left-right direction and engagement part 340.

Main body 349 is a portion that comes into contact with elastic member 33 from below and presses elastic member 33. Here, main body 349 has pressing projection part 3491 on the upper surface facing elastic member 33. Pressing projection part 3491 has a shape that fits into recess 330 on the lower surface of elastic member 33. As illustrated in FIG. 6, front end part 3490 of main body 349 protrudes forward from pressing projection part 3491. Front end part 3490 of main body 349 comes into contact with the lower end of front end wall 3301 and the lower surface of front wall 2321 (rear part 23) of wall part 232 so as to cover front end wall 3301 of elastic member 33.

Engagement part 340 is a portion of pressing member 34 attached to rear part 23 of housing 2. Engagement part 340 includes a pair of first engagement parts 341 and second engagement part 342.

As illustrated in FIGS. 3 and 4, the pair of first engagement parts 341 is provided so as to protrude upward from both end surfaces of main body 349 in the left-right direction. First engagement part 341 has a rectangular frame shape. First engagement part 341 engages with the side wall of rear part 23 by being hooked on first projection part 237 (see FIG. 14) provided on the left or right outer side surface of rear part 23 (see FIG. 2). The pair of first engagement parts 341 engages with the pair of sidewalls of rear part 23 in the left-right direction in this manner.

As illustrated in FIGS. 3 and 4, second engagement part 342 is a protrusion. Second engagement part 342 is provided on the lower surface of main body 349 so as to protrude upward from the center in the left-right direction and the end in the forward-rearward direction (here, the rear end). Second engagement part 342 has a plate-like shape and has hook 3421 at the tip (upper end) thereof. Hook 3421 at the tip of second engagement part 342 is hooked on second projection part 238 (see FIG. 13) provided on the rear surface of rear part 23, thereby engaging with the rear end wall of rear part 23 (see FIG. 6). Second engagement part 342 engages with the end wall of rear part 23 in the forward-rearward direction in this manner. Here, second engagement part 342 engages with the rear end wall of rear part 23.

The pair of first engagement parts 341 and second engagement part 342 are engaged with rear part 23 in a state where connection target member C11 and elastic member 33 are sandwiched between facing surface 2330 of rear part 23 and pressing member 34, whereby second seal member 32 is attached to rear part 23 (see FIG. 6).

As illustrated in FIG. 6, rear seal member 3 (here, elastic member 33) is disposed so as to close the rear opening of through hole 25 of housing 2. When pressing member 34 presses elastic member 33, front end wall 3301 of elastic member 33 comes into contact with the periphery of the opening on the rear side of through hole 25 so that adhesion of the front-end wall to inclined surface 26 of front wall 2321 of wall part 232 is enhanced. Rear seal member 3 seals a gap between the rear opening of through hole 25 of housing 2 and connection target member C11.

As illustrated in FIG. 6, the front surface of second seal member 32 (here, elastic member 33) abuts on inclined surface 236 of rear part 23. As a result, the front surface of second seal member 32 and inclined surface 236 of rear part 23 easily come into planar contact with each other, and the sealing properties (waterproof properties and dust-proof properties) can improve.

In addition, when pressing member 34 presses elastic member 33 and elastic member 33 is elastically deformed, the adhesion of elastic member 33 with the bottom surface of insertion recess 233 of rear part body 231 (bottom surface 2331 formed between recess 235 of rear part 23 and inclined surface 236) can be enhanced in the vicinity of the rear side of the opening of through hole 25 in the left-right direction with respect to connection target member C11, and the periphery of the gap between rear part body 231 and connection target member C11 can be closed. This can improve sealing properties (waterproof properties and dust-proof properties).

Elastic member 33 is also in contact with front surface 2332 of rear wall 2322 (side surface of insertion recess 233: see FIG. 13).

### (1.3.4) Fixing Member

Fixing member 4 is attached to front part 22 of housing 2. Fixing member 4 is a member for fixing front seal member 30 to housing 2. Fixing member 4 can abut on (the front-end surface of) front seal member 30. Fixing member 4 prevents front seal member 30 from falling forward.

As illustrated in FIGS. 3 and 4, fixing member 4 integrally includes lower cover 41, a pair of lateral covers 42, and upper cover 43.

Lower cover 41 has a plate-like shape elongated in the left-right direction and has a thickness in the up-down direction. Lower opening part 410 penetrating lower cover 41 in the up-down direction is formed in lower cover 41. Lower opening part 410 is a hole elongated in the left-right direction and has a rectangular shape in top view. Fixing member 4 has lower opening part 410 like this.

Two lower opening parts 410 are formed in lower cover 41. Two lower opening parts 410 are arranged in the forward-rearward direction. Hereinafter, front lower opening part 410 of two lower opening parts 410 is also referred to as "first lower opening part 411", and rear lower opening part 410 is also referred to as "second lower opening part 412".

As illustrated in FIG. 6, lower opening part 410 exposes the plurality of conductors 5 (conductor-side connecting parts 501) of connection target member C11 downward in a state where connection target member C11 is disposed in connector C1. First lower opening part 411 exposes the plurality of first connecting parts 511 of the plurality of first conductors 51 downward. Second lower opening part 412 exposes the plurality of second connecting parts 521 of the plurality of second conductors 52 downward. The plurality of conductors 5 (conductor-side connecting parts 501) of connection target member C11 can be visually recognized from below through lower opening part 410.

As illustrated in FIGS. 3 and 4, each of the pair of lateral covers 42 includes lower wall part 421, side wall part 422, and front wall part 423.

Lower wall part 421 of lateral cover 42 has a plate-like shape having a thickness in the up-down direction. Lower wall part 421 is coupled to the left end or the right end of lower cover 41. Positioning hole 420 having an L shape in top view is formed in a coupling portion between lower wall part 421 and lower cover 41. The rear end surface of lower wall part 421 is flush with the rear end surface of lower cover 41.

Side wall part 422 of lateral cover 42 has a plate-like shape having a thickness in the left-right direction. Side wall part 422 has a wall shape protruding upward from the left end or the right end of lower wall part 421.

Side wall part 422 of lateral cover 42 is formed with lateral projection 4221 protruding in the left-right direction.

Front wall part 423 of lateral cover 42 has a plate-like shape having a thickness in the forward-rearward direction. The lower end of front wall part 423 is coupled to the front end of lower wall part 421, and the outer end of front wall part 423 in the left-right direction is coupled to the front end of side wall part 422. Front wall part 423 forms a step protruding upward with respect to the front end of upper cover 43 (see FIG. 3). Front wall part 423 forms a step protruding downward with respect to the front end of lower cover 41 (see FIG. 4).

In a connected state where connector C1 and mating connector C2 are connected, lateral projection 4221 and front wall part 423 abut on the inner surface of mating recess 90 of mating housing 9 of mating connector C2.

Upper cover 43 has a plate-like shape having a thickness in the up-down direction. Upper cover 43 is coupled to the pair of lateral covers 42 such that front opening part 430 that is open in the forward-rearward direction is formed. More specifically, upper cover 43 connects the upper ends of front wall parts 423 of the pair of lateral covers 42 in the left-right direction. With such a configuration, fixing member 4 has front opening part 430 that is open in the forward-rearward direction. In a state where fixing member 4 is attached to front part 22, contact parts 101 of the plurality of terminals 10 are exposed forward through front opening part 430 (see FIG. 6). Since fixing member 4 includes upper cover 43, the strength of fixing member 4 improves.

As illustrated in FIG. 3, the dimension of upper cover 43 in the forward-rearward direction is smaller than the dimension of lower cover 41 in the forward-rearward direction. More specifically, the dimension of upper cover 43 in the forward-rearward direction is defined such that the rear end of upper cover 43 is positioned on the front side with respect to the front edge of lower opening part 410 (first lower opening part 411) formed in lower cover 41 (see FIG. 6).

As illustrated in FIGS. 3 and 4, fixing member 4 further integrally includes a pair of projecting wall parts 44. The projecting wall part 44 has a plate-like shape having a thickness in the left-right direction. The projecting wall part 44 extends in the up-down direction. The projecting wall part 44 protrudes upward from an edge portion of positioning hole 420 in fixing member 4. The pair of projecting wall parts 44 is positioned between side wall parts 422 of the pair of lateral covers 42.

Projection 441 protruding inward in the left-right direction is formed on an inner surface in the left-right direction at the upper end of projecting wall part 44. Projection 441 has a projecting rib shape extending in the forward-rearward direction.

Fixing member 4 is attached to front part 22 from below front part 22. Positioning projection 223 of front part 22 is fitted into positioning hole 420 of fixing member 4. Then, the pair of projecting wall parts 44 of fixing member 4 is inserted to be disposed into the pair of opening parts 227 of front part 22.

As illustrated in FIGS. 6 and 30, fixing member 4 (lower cover 41) abuts on second surface S2 of connection target member C11. Lower cover 41 includes abutment part 414 that abuts on second surface S2 of connection target member C11. Here, abutment part 414 is formed so as to protrude upward around lower opening part 410 (see FIG. 3). The upper end of abutment part 414 abuts on second surface S2 of connection target member C11 (see FIG. 6).

Abutment part 414 is formed in a frame shape surrounding lower opening part 410. Here, two abutment parts 414 are formed around two lower opening parts 410 (first lower opening part 411 and second lower opening part 412), respectively. Hereinafter, abutment part 414 formed around first lower opening part 411 is also referred to as "first abutment part 4141", and abutment part 414 formed around second lower opening part 412 is also referred to as "second abutment part 4142" (see FIG. 30).

Fixing member 4 further includes coupling part 4143 that connects outer ends of first abutment part 4141 and second abutment part 4142 in the left-right direction (see FIG. 3).

As illustrated in FIG. 4, fixing member 4 includes coupling part 415 that couples first abutment part 4141 and second abutment part 4142. Coupling part 415 is formed to be long in the left-right direction, and couples the lower end of the rear edge portion of first abutment part 4141 and the lower end of the front edge portion of second abutment part 4142 (see FIG. 30).

As illustrated in FIG. 30, with respect to first connecting part 511 of first conductor 51 and second connecting part 521 of second conductor 52 arranged in the forward-rearward direction, two abutment parts 414 (first abutment part 4141 and second abutment part 4142) abut on the lower surface (second surface S2) of the portion corresponding to first connecting part 511 of first conductor 51 and the lower surface (second surface S2) of the portion corresponding to second connecting part 521 of second conductor 52 in connection target member C11, respectively.

At least one of two abutment parts 414 (first abutment part 4141 and second abutment part 4142) abuts on second surface S2 of connection target member C11 at a position between two connecting parts 104 (first connecting part 114 of first terminal 11 and second connecting part 124 of second terminal 12) arranged in the forward-rearward direction. Abutment part 414 of fixing member 4 may overlap two connecting parts 104 (first connecting part 114 of first terminal 11 and second connecting part 124 of second terminal 12) arranged in the forward-rearward direction in the up-down direction.

Abutment part 414 of fixing member 4 abuts on a portion corresponding to at least two (a plurality of) conductors 5 arranged in the left-right direction on second surface S2 of connection target member C11. First abutment part 4141 abuts on each portion corresponding to at least two first conductors 51 arranged in the left-right direction on second surface S2 of connection target member C11. Second abutment part 4142 abuts on each portion corresponding to at least two second conductors 52 arranged in the left-right direction on second surface S2 of connection target member C11.

Here, abutment part 414 abuts on portions corresponding to the plurality of conductors 5 arranged in the left-right direction on second surface S2 of connection target member C11 so as to be continuously adjacent thereto.

### (1.4) Assembly of Connector Device

A method for assembling connector device C100 will be described with reference to FIGS. 15 - 27. In FIGS. 19 - 27, connector device C100 is illustrated upside down for convenience.

First, as illustrated in FIGS. 15 - 19, contact parts 101 of the plurality of terminals 10 are housed in the plurality of storage spaces 2200 of housing 2. Front seal member 30 is inserted from the front side into the annular recess space between skirt 24 and front part 22 of housing 2 and is disposed along the outer periphery of front part 22.

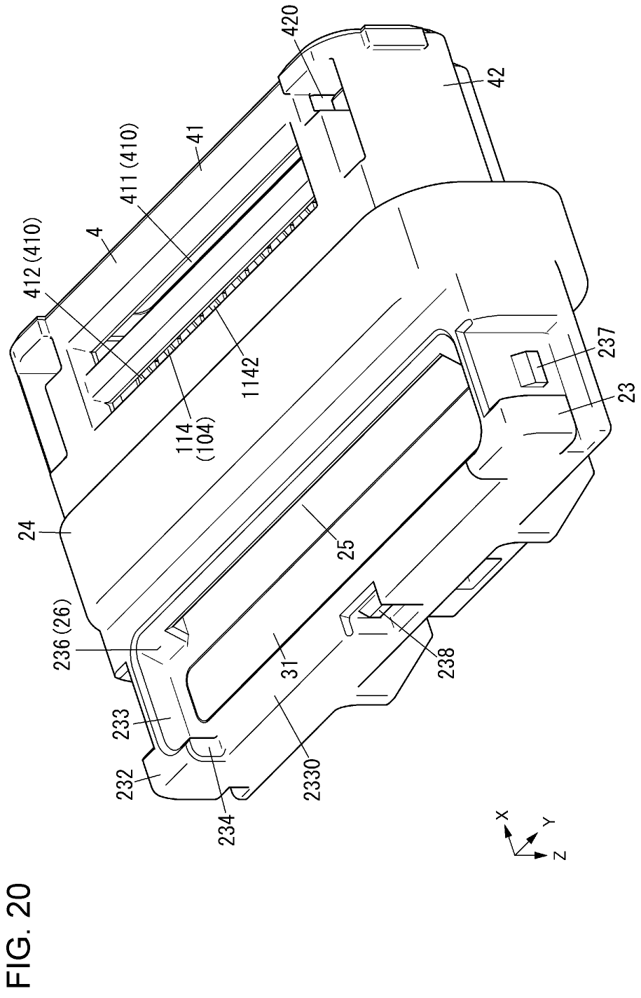

Next, as illustrated in FIG. 20, first seal member 31 of rear seal member 3 is fitted into recess 235 of rear part 23 of housing 2 from below.

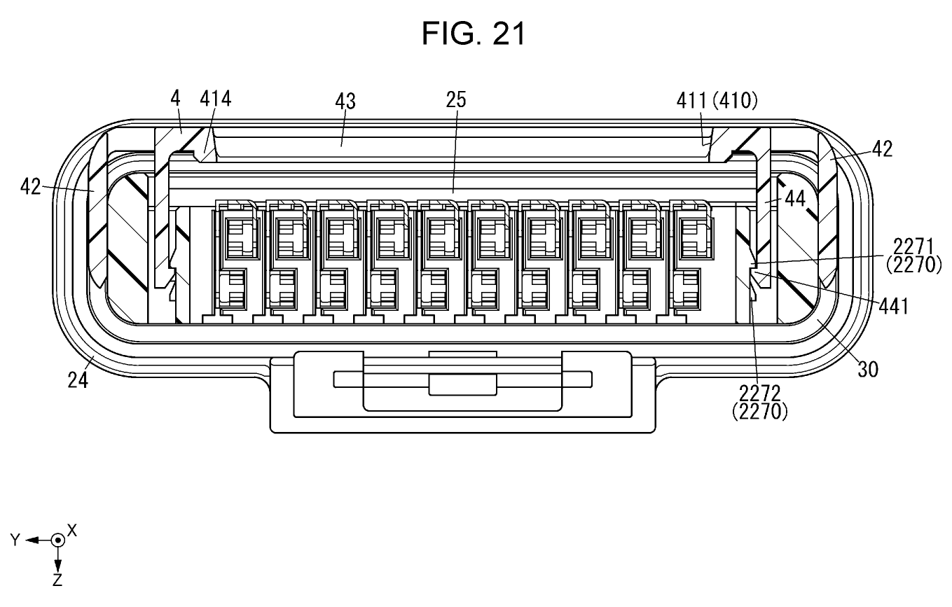

The pair of projecting wall parts 44 of fixing member 4 is inserted into the pair of opening parts 227 of front part 22, and fixing member 4 is fitted into disposition recess 222 of front part 22 from below. At this stage, as illustrated in FIG. 21, projecting wall part 44 of fixing member 4 is not pushed into the depth (near the upper end) of opening part 227, and projection 441 of projecting wall part 44 of fixing member 4 is hooked on first projection 2271 on the lower side of two projections 2270 (first position; temporary attachment state of fixing member). FIG. 21 is a sectional view of connector module C10 in the state of FIG. 20 taken along a virtual plane passing through first lower opening part 411 and orthogonal to the X-axis.

Front part 22 and fixing member 4 have the first holding mechanism (projection 441 and first projection 2271) in this manner. The first holding mechanism holds fixing member 4 at the first position where the distance in the up-down direction between fixing member 4 and the plurality of terminals 10 is relatively long with respect to front part 22. At the first position, projection 441 and first projection 2271 are engaged with each other, and thus, fixing member 4 can be prevented from coming off below front part 22. Since front part 22 and fixing member 4 have the first holding mechanism, connector C1 before connection target member C11 is connected can be easily conveyed while fixing member 4 is temporarily held by front part 22.

Here, when projecting wall part 44 is inserted into opening part 227, projection 441 comes over first projection 2271, and thus, a click feeling is generated. As a result, the worker (or the work facility) can determine that fixing member 4 has moved to the first position.

Even in this state (state in which fixing member 4 is at the first position), fixing member 4 can prevent front seal member 30 from falling forward. In this state, as viewed from the front (see FIG. 21), through hole 25 is not closed by fixing member 4.

As illustrated in FIGS. 20 and 21, lower opening part 410 exposes the plurality of connecting parts 104 of the plurality of terminals 10 downward in a state where connection target member C11 is not disposed in connector C1.

Next, as illustrated in FIG. 22, connection target member C11 is inserted into through hole 25 from the rear through rear end recess 234 and insertion recess 233. Connection target member C11 is disposed between the pair of projecting walls 2320. Here, because through hole 25 has a dimension in the right-left direction larger than a dimension in the up-down direction, and a dimension in the right-left direction of through hole 25 is larger than a dimension in the right-left direction of connection target member C11, the plurality of conductors 5 of plate-like connection target member C11 can be easily disposed so as to correspond to connecting parts 104 of the plurality of terminals 10, respectively.

For example, the worker inserts connection target member C11 to the position where opening part 60 overlaps second projection part 238 in the up-down direction. In this manner, opening part 60 also functions as an identification part of an insertion position for adjusting the position of connection target member C11 in the forward-rearward direction.

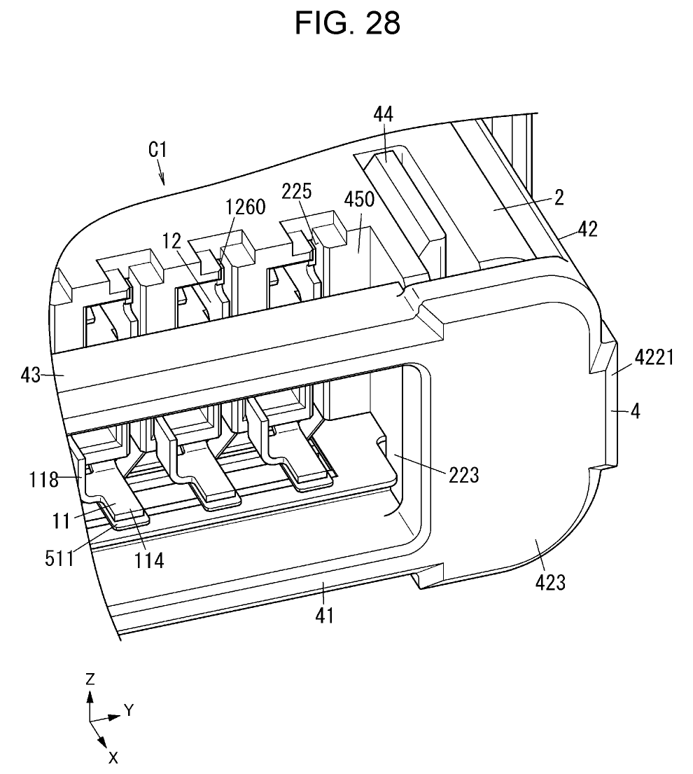

As illustrated in FIG. 28, when connection target member C11 is inserted, cutout 601 of connection target member C11 abuts on positioning projection 223, and thus, the insertion position of connection target member C11 in the forward-rearward direction can be restricted.

Here, second connecting part 124 of second terminal 12 has plate-like guide plate part 1242 extending upward from the rear end of flat part 1241. First connecting part 114 of first terminal 11 has plate-like guide plate part 1142 extending upward from the rear end of flat part 1141. That is, connecting part 104 of terminal 10 has plate-like guide plate part 1042 extending upward from the rear end of flat part 1041 (see FIG. 6). By guiding connection target member C11 with guide plate part 1042, connection target member C11 can be smoothly inserted to the lower side of flat part 1041.

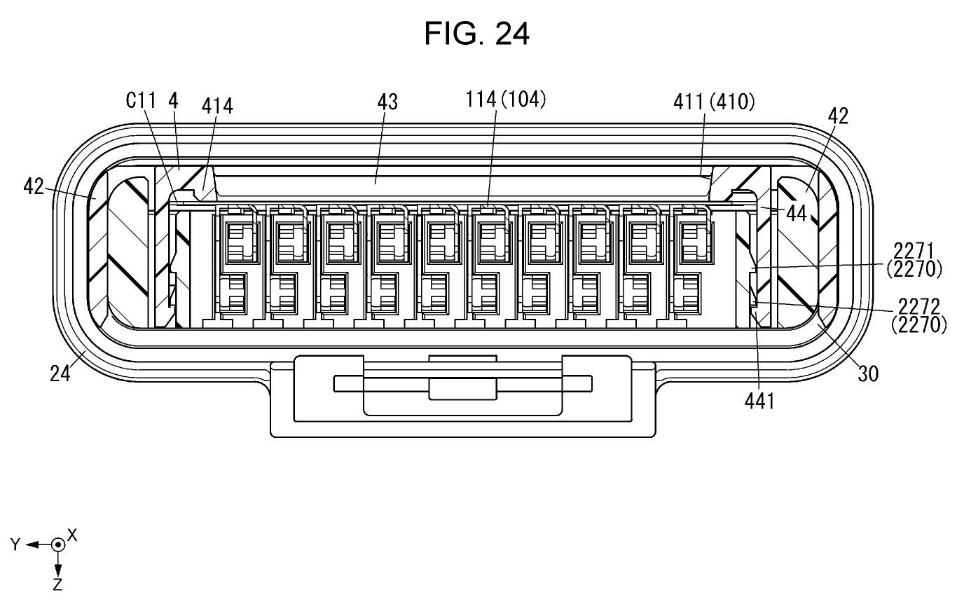

Next, as illustrated in FIGS. 23 and 24, fixing member 4 is further pushed into opening part 227 (see virtual arrow P1 in FIG. 23). In fixing member 4, projection 441 of projecting wall part 44 is pushed to the position where the projecting wall part is caught by upper second projection 2272 of two projections 2270 (second position; fully attached state of the fixing member). When projection 441 is caught by second projection 2272, fixing member 4 is held at the second position.

Front part 22 and fixing member 4 have the second holding mechanism (projection 441 and second projection 2272) in this manner. The second holding mechanism holds fixing member 4 at the second position where the distance in the up-down direction between fixing member 4 and the plurality of terminals 10 is relatively short with respect to front part 22. At the second position, projection 441 and second projection 2272 are engaged with each other, and thus, fixing member 4 can be prevented from coming off below front part 22.

At least either projecting wall part 44 or lateral cover 42 of fixing member 4 is pressed against front part 22 at the first position and the second position, whereby fixing member 4 is held by front part 22.

Here, also when fixing member 4 is moved from the first position to the second position, projection 441 comes over second projection 2272, and thus, a click feeling is generated. As a result, the worker (or the work facility) can determine that fixing member 4 has moved to the second position.

In the present exemplary embodiment, because housing 2 is a member that does not elastically deform (or has small elastic deformation) as compared with fixing member 4, projection 2270 (first projection 2271 and second projection 2272) is provided in housing 2. Thus, the magnitude of the click feeling to be generated can be adjusted by the magnitude of the elastic deformation of projecting wall part 44 when fixing member 4 is moved to the first position and the magnitude of the elastic deformation of projecting wall part 44 when fixing member 4 is moved from the first position to the second position. In addition, as compared with a case where a projection is formed on projecting wall part 44 of fixing member 4 instead of projection 2270 of housing 2, the amount of movement in the left-right direction due to elastic deformation of projecting wall part 44 (amount of movement due to elastic deformation) can be suppressed, and the size of opening part 227 can be suppressed. As opening part 227 (cavity portion) can be reduced, the strength of housing 2 can improve as a result.

In a state where fixing member 4 is pushed to the second position, connection target member C11 is sandwiched between connecting parts 104 of the plurality of terminals 10 and fixing member 4 (see FIG. 24). That is, the second position of fixing member 4 is a position where fixing member 4 (abutment part 414) abuts on second surface S2 of connection target member C11.

Next, elastic member 33 of rear seal member 3 is fitted into insertion recess 233 of rear part 23 from below (see FIG. 25), and pressing member 34 is further fitted. The pair of first engagement parts 341 of pressing member 34 is hooked on the pair of first projection parts 237 of the rear part of housing 2, and second engagement part 342 (protrusion) of pressing member 34 is hooked on second projection part 238 through opening part 60 of connection target member C11. Thus, connection target member C11 is fixed to housing 2. By inserting second engagement part 342 of pressing member 34 into opening part 60, the position of connection target member C11 can be regulated in the forward-rearward direction.

In the present exemplary embodiment, rear seal member 3 and fixing member 4 are attached to housing 2 from the same side (one side in the up-down direction). As a result, the attachment of rear seal member 3 and the full attachment of fixing member 4 can be continuously performed from the same direction with the orientation of housing 2 kept constant, and the workability of the assembly work can improve.

By attaching pressing member 34 to rear part 23, first seal member 31 and second seal member 32 come into contact with each other on both sides in the left-right direction with connection target member C11 interposed therebetween, as illustrated in FIG. 26. FIG. 26 is a sectional view of connector module C10 with pressing member 34 attached, taken along a virtual plane passing through first projection part 237 and orthogonal to the X-axis.

Thereafter, as illustrated in FIG. 27, laser light L10 is applied from below through lower opening part 410 of fixing member 4, whereby the plurality of terminals 10 of connector C1 and the plurality of conductors 5 of connection target member C11 connect to each other through laser welding. That is, first connecting part 114 of first terminal 11 and first connecting part 511 of first conductor 51 connect to each other with laser light L11 being applied through first lower opening part 411. When laser light L12 is applied through second lower opening part 412, second connecting part 124 of second terminal 12 and second connecting part 521 of second conductor 52 connect to each other. At this time, because laser welding is performed in a state where connection target member C11 is pressed against terminal 10 by fixing member 4, the occurrence of connection failure is suppressed. In addition, because projection 441 of fixing member 4 is hooked on projection 2270 of housing 2, the pressing force with fixing member 4 increases.

As described above, in the present exemplary embodiment, laser welding is performed after the step of disposing second seal member 32 into insertion recess 233. However, the laser welding is not limited to this configuration, and a step of disposing second seal member 32 in insertion recess 233 may be performed after laser welding.

In the present exemplary embodiment, terminal 10 has connecting part 104 coupled to the lower end of leg 108 of coupling part 105 via curved part 109. As a result, the connection area between terminal 10 and conductor 5 increases, and the connection reliability of the connection portion between terminal 10 of connector C1 and conductor 5 of connection target member C11 can improve.

In the present exemplary embodiment, protrusion 1144 of first connecting part 114 of first terminal 11 protrudes forward so as to be away from second connecting part 124 of second terminal 12, and on the other hand, protrusion 1244 of second connecting part 124 of second terminal 12 protrudes backward so as to be away from first connecting part 114 of first terminal 11. That is, connecting part 104 includes coupling connecting part 1043 coupled to curved part 109 and protrusion 1044 protruding from coupling connecting part 1043 to at least either the front side or the rear side. This makes it easy to secure the insulation distance by increasing the distance between first connecting part 114 and second connecting part 124 while increasing the connection area of connecting part 104.

A laser welding mark is formed at a junction portion between each of the plurality of conductors 5 of connection target member C11 and connecting part 104 of the corresponding terminal 10 among the plurality of terminals 10.

In the present exemplary embodiment, as illustrated in FIG. 6, in a state where terminal 10 and connection target member C11 are connected, connection target member C11 is disposed in an inclined manner so as to linearly extend obliquely downward from the opening on the rear side of through hole 25 in rear part 23 to the rear side of connecting part 104 of terminal 10. Since connection target member C11 is sandwiched between connecting part 104 of the plurality of terminals 10 and fixing member 4, even in a state where connection target member C11 is disposed in an inclined manner, it is possible to perform sealing with rear seal member 3 while improving connection reliability of joint by laser welding between connecting part 104 of terminal 10 and connection target member C11.

In this manner, the method for connecting connection target member C11 and connector C1 (the method for assembling connector module C10) includes a connection target member disposition step and a laser connection step.

The connection target member disposition step includes disposing connection target member C11 in through hole 25 of housing 2 (see FIGS. 22 to 24). In the connection target member disposition step, for example, connection target member C11 is inserted into through hole 25 from the rear, whereby connection target member C11 is disposed in through hole 25.

In the connection target member disposition step, connection target member C11 is inserted into through hole 25 in a state where fixing member 4 is held at the first position where the distance between fixing member 4 and the plurality of terminals 10 in the up-down direction is relatively long (see FIG. 22). In the connection target member disposition step, after connection target member C11 is inserted into through hole 25, fixing member 4 is moved to the second position where the distance between fixing member 4 and the plurality of terminals 10 in the up-down direction is relatively short (see FIGS. 23 and 24).

The laser connection step includes irradiating a position where the plurality of connecting parts 104 of the plurality of terminals 10 and the plurality of conductors 5 (conductor-side connecting parts 501) of connection target member C11 overlap with each other with laser light L10 to connect connecting parts 104 of the plurality of terminals 10 and the plurality of conductors 5, respectively (see FIG. 26). In the laser connection step, laser light L10 is emitted through lower opening part 410 formed in fixing member 4.

As illustrated in FIG. 28, in connector C1, upper opening part 450 for exposing the plurality of terminals 10 upward in a state where fixing member 4 is attached to housing 2 is formed. Upper opening part 450 is an opening formed between the front edge of the upper surface of housing 2 and the rear edge of upper cover 43 of fixing member 4.

Here, a portion (for example, leg 118 of first terminal 11) away from first connecting part 114 is exposed upward through upper opening part 450 and is visible. As a result, a probe for inspection can be brought into contact with leg 118 through upper opening part 450, and it is possible to inspect whether first terminal 11 and first conductor 51 are normally and electrically connected. In particular, because a probe can be brought into contact with a portion other than first connecting part 114 (for example, leg 118), the possibility of erroneous determination of the electrically connected state can be reduced as compared with a case where the probe is brought into contact with first connecting part 114 to perform inspection. When erroneous determination occurs, for example, although first connecting part 114 of first terminal 11 and first connecting part 511 of first conductor 51 are not actually connected but there is a gap, first connecting part 114 is pressed by pressing of the probe, and thus, first connecting part 114 comes into contact with first connecting part 511, and first terminal 11 and first conductor 51 may be connected.

In addition, by bringing a probe into contact with lower opening part 410 through upper opening part 450 on the side opposite to the lower opening part from which irradiation with laser light L10 is performed, it is possible to inspect whether first terminal 11 and first conductor 51 are normally and electrically connected.

A portion (for example, leg 128 of second terminal 12) away from first connecting part 114 is exposed upward through upper opening part 450 and is visible. As described above, for example, projection part 1260 of main body 126 of second coupling part 125 of second terminal 12 is exposed upward via second groove 225 as a portion away from first connecting part 114 and can be visually recognized. As a result, a probe for inspection can be brought into contact with leg 128 or projection part 1260 through upper opening part 450, and it is possible to inspect whether second terminal 12 and second conductor 52 are normally and electrically connected.

### (1.5) Mating Connector

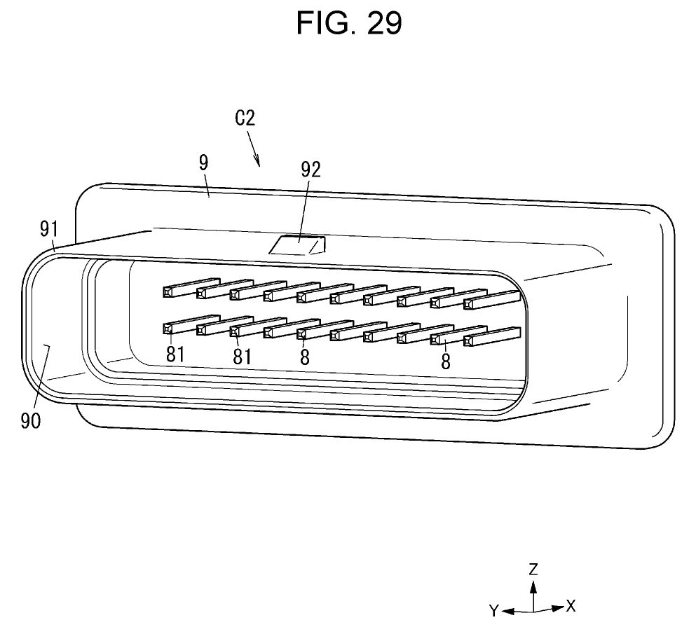

As illustrated in FIGS. 1, 2, and 29, mating connector C2 includes a plurality of mating terminals 8 and mating housing 9 that holds the plurality of mating terminals 8.

Mating housing 9 holds a plurality of mating terminals 8. Mating housing 9 is formed using, for example, an electrically insulating resin material.

Here, mating housing 9 has hollow cylindrical tubular part 91 that is open rearward. Tubular part 91 has a substantially rectangular cylindrical shape in rear view. Mating recess 90 is formed in tubular part 91 so as to open rearward. A part (front part 22) of housing 2 of connector C1 is housed in mating recess 90. Lock projection 92 on which lock part 28 of housing 2 of connector C1 is to be hooked is formed on the upper surface of the upper wall of tubular part 91.

In each of the plurality of mating terminals 8, first end 81 is positioned inside mating recess 90, and second end 82 passes through the bottom of tubular part 91 and is positioned in front of tubular part 91. The plurality of mating terminals 8 respectively connect to the plurality of terminals 10 when first ends 81 come into contact with contact parts 101 of the plurality of terminals 10 of connector C1 (sandwiched between the upper contact point part and the lower contact point part).

### (1.6) Connected State

Connector module C10 including connector C1 and mating connector C2 connect to each other by relatively moving in the forward-rearward direction. As illustrated in FIG. 30, in a connected state where connector C1 and mating connector C2 are connected, the plurality of terminals 10 of connector C1 are connected to the plurality of mating terminals 8 of mating connector C2, respectively. In the connected state, front part 22 of housing 2 of connector C1, fixing member 4, and front seal member 30 are housed in mating recess 90 of mating housing 9 of mating connector C2. The rear end of mating recess 90 (opening terminal end of tubular part 91) is inserted to a coupling part between main body 21 and skirt 24. Since the periphery of front part 22 is housed in mating recess 90 of mating housing 9, the plurality of terminals 10 of connector C1 and connection target member C11 are protected by tubular part 91 of mating housing 9. In addition, in the connected state, fixing member 4 abuts on the side surface of mating recess 90 of mating housing 9 of mating connector C2, thereby reducing rattling in the connected state.

As illustrated in FIG. 30, in the connected state, the inner surface (side surface of mating recess 90) of tubular part 91 of mating housing 9 of mating connector C2 comes into circumferential contact with outer projection part 302 of front seal member 30 of connector C1. Front seal member 30 is sandwiched between front part 22 of housing 2 and tubular part 91 of mating housing 9 to expand forward and backward, comes into contact with step 221 portion of housing 2, and comes into contact with fixing member 4 (rear ends of lower cover 41 and lateral cover 42). The outer peripheral surface of front part 22 comes into circumferential contact with inner projection part 301 of front seal member 30. This improves sealing properties (waterproof properties, dust-proof properties, and the like) with front seal member 30.

As illustrated in FIG. 30, in the connected state, space S10 in which terminal 10 of connector C1 and mating terminal 8 of mating connector C2 are housed is sealed by front seal member 30 and rear seal member 3. This can effectively suppress entry (see virtual arrows W1, W2 in FIG. 30) of moisture or the like into space S10. In particular, a portion (connecting part 104, conductor-side connecting part 501) of connector module C10 connected by laser welding is positioned on the front side with respect to the seal members (front seal member 30 and rear seal member 3), and this portion can be sealed with the seal member. Thus, both improvement of workability by laser welding and securing of waterproof properties and dust-proof properties can be achieved. Although not particularly limited, in connector device C100 of the present exemplary embodiment, waterproof performance of about IPX7 can be realized.

In particular, in the present exemplary embodiment, because connection target member C11 is inserted into and connected to through hole 25, it is easy to achieve both connection by laser welding and waterproof properties and dust-proof properties. Further, in connector device C100 of the present exemplary embodiment, space S10 can be more reliably sealed (waterproof, dustproof, and the like) by forming at least either front seal member 30 or rear seal member 3.

### (2) Modifications

The exemplary embodiment described above is merely one of various exemplary embodiments of the present disclosure. The exemplary embodiment described above can be variously changed according to a design and the like as long as the object of the present disclosure can be achieved. Hereinafter, modifications of the exemplary embodiment will be listed. The exemplary embodiment described above and the modifications to be described below can be applied in appropriate combination. In the following description of each modification, the description of the same configuration as the above exemplary embodiment may be appropriately omitted.

### (2.1) Modification 1

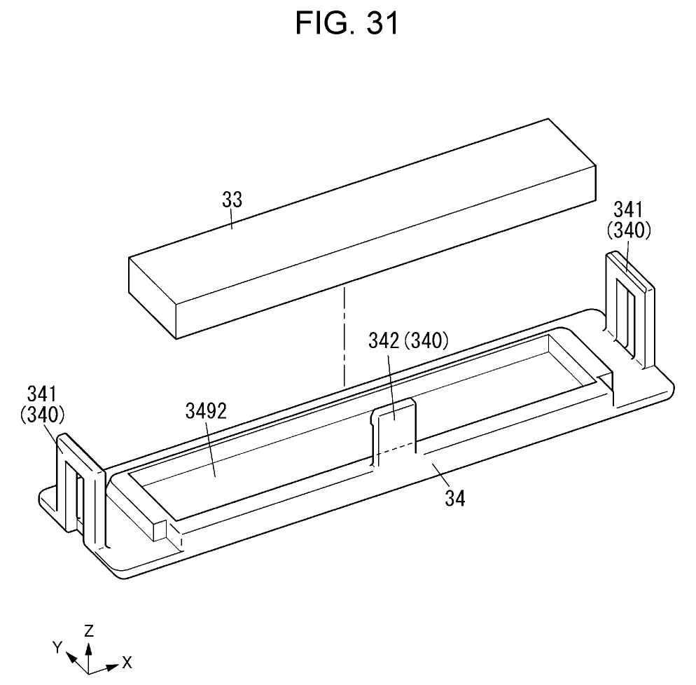

In connector device C100 of the present exemplary modification, as illustrated in FIG. 31, main body 349 of pressing member 34 of rear seal member 3 has pressing recess 3492. Pressing recess 3492 is a rectangular recess into which at least a part of rectangular parallelepiped elastic member 33 is fitted. In this case, the front end of the projecting peripheral wall of recess 3492 can be formed in contact with the rear surface of front wall 2321 (rear part 23) of wall part 232 so as to seal through hole 25.

In this manner, pressing member 34 has pressing recess 3492 or pressing projection part 3491 (see FIGS. 3 and 4) on the surface facing elastic member 33.

It is not essential that pressing member 34 has pressing projection part 3491 or pressing recess 3492. Pressing member 34 does not have to have any of them. As illustrated in FIG. 31, elastic member 33 does not have to have recess 330 on the lower surface.

### (2.2) Modificiation 2

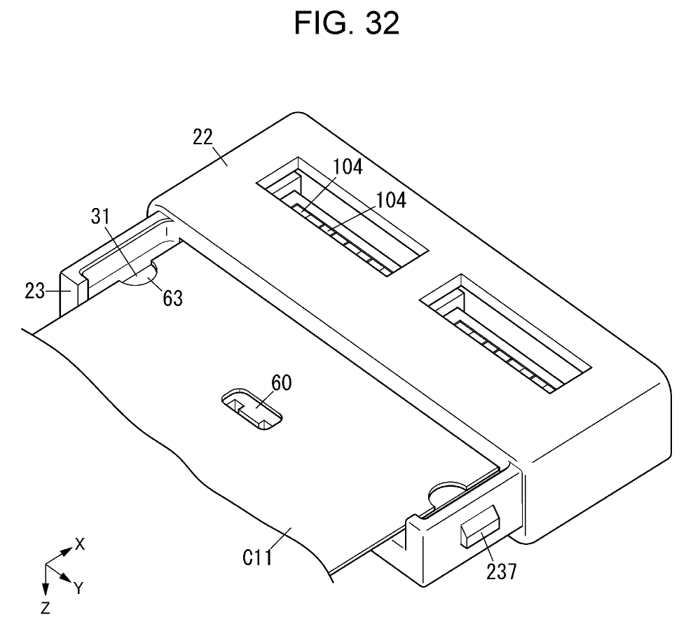

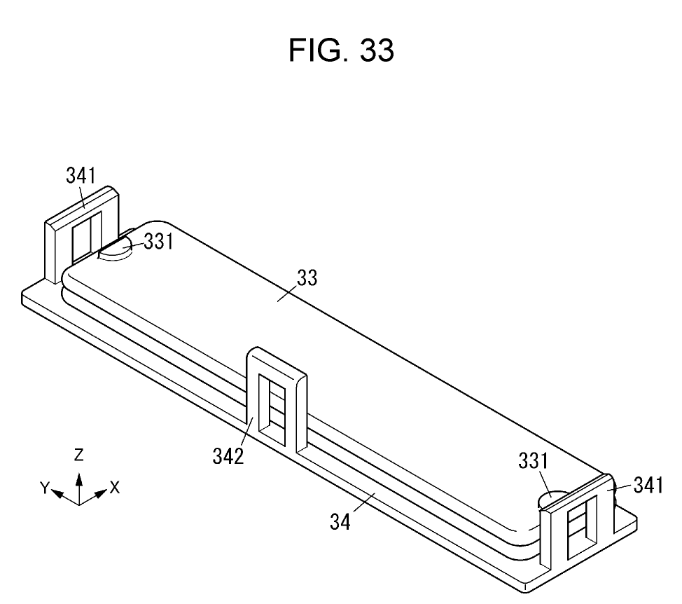

In connector device C100 of the present modification, as illustrated in FIG. 32, the dimension of first seal member 31 in the left-right direction is the same as or smaller than the dimension of connection target member C11 in the left-right direction. Connection target member C11 has cutouts 63 for exposing left and right end portions of first seal member 31 on both sides in the left-right direction. As illustrated in FIG. 33, elastic member 33 of second seal member 32 has projection part 331 having shapes to be fitted into cutouts 63 at both ends in the left-right direction.

Then, projection part 331 abuts on first seal member 31 with cutout 63 interposed therebetween, and thus, first seal member 31 and elastic member 33 abut on each other on both sides in the left-right direction with connection target member C11 interposed therebetween.

In the present modification, rear part 23 can be downsized in the left-right direction. In addition, first seal member 31 and second seal member 32 easily come into contact with each other, and the sealing properties with rear seal member 3 can improve.

### (2.3) Other modifications

In one modification, the plurality of terminals 10 may include only either first terminal 11 or second terminal 12. In this case, the shape of storage part 220, the shape of conductor 5 of connection target member C11, and the like can also be appropriately changed.

In one modification, second seal member 32 of rear seal member 3 may be a single member. In one specific example, elastic member 33 and pressing member 34 may be integrally formed by two-color molding.

In one modification, partition wall 27 of housing 2 may have unevenness or a hole. Through hole 25 may partially communicate with storage space 2200.

In one modification, storage part 220 may be formed in main body 21 or rear part 23 (rear part body 231) in addition to front part 22.

In one modification, the projecting wall part 44 of the fixing member 4 may have a plurality (for example, two) of projections 441 at different positions in the vertical direction. In such a case, front part 22 of housing 2 can have one projection 2270.

In one modification, either projection 441 or projection 2270 may be a recess.

In one modification, in a state where terminal 10 and connection target member C11 are connected, connection target member C11 may be disposed so as to linearly extend in parallel to the penetrating direction of through hole 25 from rear part 23 to connecting part 104 of terminal 10 from the opening on the rear side of through hole 25. In this case, connection target member C11 can be disposed along the upper surface of through hole 25, and the lower surface of connecting part 104 of terminal 10 can be made flush with the upper surface of through hole 25. At this time, guide plate part 1042 of terminal 10 does not have to be provided.

### (3) Aspects

As is apparent from the above-described exemplary embodiment and modifications, the following aspects are disclosed in the present specification.

Connector module (C10) according to a first aspect includes connector (C1) and connection target member (C11). Connector (C1) connects to mating connector (C2) by moving relative to mating connector (C2) in a forward-rearward direction. Connection target member (C11) has a plate-like shape and includes a plurality of conductors (5). Connection target member (C11) connects to connector (C1). Connector (C1) includes a plurality of terminals (10), housing (2) that holds the plurality of terminals (10), and fixing member (4). Each of the plurality of terminals (10) includes contact part (101) and connecting part (104). Contact part (101) is in contact with corresponding mating terminal (8) among a plurality of mating terminals (8) of mating connector (C2) in a connected state where connector (C1) and mating connector (C2) are connected. Connecting part (104) connects to corresponding conductor (5) among the plurality of conductors (5) of connection target member (C11). Mating connector (C2) is positioned on a front side with respect to connector (C1), and housing (2) includes, at a front side of housing (2), front part (22) for disposing the plurality of terminals (10). Connection target member (C11) includes first surface (S1) facing connecting part (104) of each of the plurality of terminals (10) and second surface (S2) that is a surface opposite to first surface (S1). Fixing member (4) is attached to front part (22) of housing (2). Fixing member (4) abuts on second surface (S2) of connection target member (C11).

According to this aspect, laser welding can be performed in a state where connection target member (C11) is pressed against terminal (10) by fixing member (4), and the occurrence of connection failure is suppressed. As a result, the connection reliability of the connection portion between terminal (10) of connector (C1) and conductor (5) of connection target member (C11) improves.

In connector module (C10) according to a second aspect, in the first aspect, fixing member (4) includes first abutment part (4141) that abuts on first conductor (51), second abutment part (4142) that abuts on second conductor (52), and coupling part (415) that couples first abutment part (4141) and second abutment part (4142) to each other.

According to this aspect, the connection reliability of the connection portion between terminal (10) of connector (C1) and conductor (5) of connection target member (C11) improves.

In connector module (C10) according to a third aspect, in the first or second aspect, fixing member (4) includes lower opening part (410). Lower opening part (410) exposes a plurality of the connecting parts (104) of the plurality of terminals (10) downward in a state where connection target member (C11) is not disposed in connector (C1).

According to this aspect, laser welding can be performed by irradiating connecting part (104) with laser light (L10) through lower opening part (410).

In connector module (C10) according to a fourth aspect, in the third aspect, at least either fixing member (4) or the front part (22) of housing (2) includes upper opening part (450) that exposes the plurality of terminals (10) upward.

According to this aspect, a probe can be brought into contact with terminal (10) through upper opening part (450), and the connection between terminal (10) and the conductor (5) can be easily checked.

In connector module (C10) according to a fifth aspect, in any one of the first to fourth aspects, fixing member (4) includes lower cover (41) that abuts on second surface (S2) of connection target member(C11) and a pair of lateral covers (42) coupled to left and right ends of lower cover (41).

According to this aspect, the connection reliability of the connection portion between terminal (10) of connector (C1) and conductor (5) of connection target member (C11) improves.

In connector module (C10) according to sixth aspect, in the fifth aspect, fixing member (4) further includes an upper cover coupled to the pair of lateral covers (42) to form a front opening part that is open in the forward-rearward direction.

According to this aspect, contact part (101) of terminal (10) can be exposed forward through the front opening part. In addition, the strength of fixing member (4) improves.

In connector module (C10) according to a seventh aspect, in the sixth aspect, at least either fixing member (4) or housing (2) includes lower opening part (410) that exposes the plurality of conductors (5) of connection target member (C11) downward in a state where connection target member (C11) is disposed in connector (C1), and upper opening part (450) that exposes the plurality of terminals (10) upward.

According to this aspect, a probe can be brought into contact with terminal (10) through upper opening part (450) different from lower opening part (410) for emitting laser light (L10), and the connection between terminal (10) and conductor (5) can be easily checked.

In connector module (C10) according to an eighth aspect, in any one of the fifth to seventh aspects, fixing member (4) further includes a pair of projecting wall parts (44) extending in an up-down direction between the pair of lateral covers (42). The pair of projecting wall parts (44) abuts on front part (22) of housing (2).

According to this aspect, lower cover (41) abuts on second surface (S2) of connection target member (C11), and projecting wall part (44) abuts on front part (22) of housing (2), whereby fixing member (4) abuts on connection target member (C11) while abutting on housing (2). As a result, connection target member (C11) is easily pressed against terminal (10) by fixing member (4), and the connection reliability of the connection portion between terminal (10) of connector (C1) and conductor (5) of connection target member (C11) improves.

In connector module (C10) according to a ninth aspect, in any one of the fifth to eighth aspects, fixing member (4) includes projection (441) that abuts on front part (22).

According to this aspect, lower cover (41) abuts on second surface (S2) of connection target member (C11), and projection (441) abuts on front part (22) of housing (2), whereby fixing member (4) abuts on connection target member (C11) while abutting on housing (2). When projection (441) is hooked on projection (2270) of housing (2), the pressing force with fixing member (4) at the time when connection target member (C11) is pressed against terminal (10) by fixing member (4) increases, and the connection reliability of the connection portion between terminal (10) of connector (C1) and conductor (5) of connection target member (C11) improves.

In connector module (C10) according to a tenth aspect, in any one of the first to ninth aspects, fixing member (4) abuts on mating housing (9) of mating connector (C2) in the connected state where connector (C1) and mating connector (C2) are connected.

According to this aspect, rattling in the connected state can be reduced.

In connector module (C10) according to an eleventh aspect, in any one of the first to tenth aspects, connector (C1) further includes a seal member (front seal member 30) disposed along an outer periphery of front part (22). Fixing member (4) abuts on the seal member in the connected state where connector (C1) and mating connector (C2) are connected.

According to this aspect, sealing properties (waterproof properties, dust-proof properties, and the like) with the seal member can improve.

In connector module (C10) according to a twelfth aspect, in any one of the first to eleventh aspects, front part (22) of housing (2) includes at least one opening part (227) where fixing member (4) is disposed, opening part (227) penetrating in an up-down direction.

According to this aspect, fixing member (4) (projecting wall part 44) can be disposed in opening part (227).

In connector module (C10) according to a thirteenth aspect, in any one of the first to twelfth aspects, housing (2) is formed with through hole (25) penetrating housing (2) in the forward-rearward direction. Connection target member (C11) is disposed in through hole (25).

According to this aspect, connection target member (C11) disposed in through hole (25) can be pressed against terminal (10) by fixing member (4), and the occurrence of a connection failure is suppressed.

In connector module (C10) according to a fourteenth aspect, in any one of the first to thirteenth aspects, connection target member (C11) further includes base material (6) having a plate-like shape provided with the plurality of conductors (5). A laser welding mark is formed at a junction portion between each of the plurality of conductors (5) of connection target member (C11) and connecting part (104) of corresponding terminal (10) among the plurality of terminals (10).

According to this aspect, laser welding can be performed in a state where connection target member (C11) is pressed against terminal (10) by fixing member (4), and the occurrence of connection failure is suppressed.

Connector device (C100) according to a fifteenth aspect includes connector module (C10) according to any one of the first to fourteenth aspects and mating connector (C2). Mating connector (C2) includes the plurality of mating terminals (8) and mating housing (9) that holds the plurality of mating terminals (8). Front part (22) and fixing member (4) of connector (C1) are housed in mating recess (90) that is open to a rear side of mating housing (9) in the connected state where connector (C1) and mating connector (C2) are connected.

According to this aspect, it is possible to provide connector device (C100) in which the connection reliability of the connection portion between terminal (10) of connector (C1) and conductor (5) of connection target member (C11) is improved.

Mating connector (C2) according to a sixteenth aspect connects to connector module (C10) according to any one of the first to fourteenth aspects. Mating connector (C2) includes the plurality of mating terminals (8) and mating housing (9) that holds the plurality of mating terminals (8). Mating housing (9) includes mating recess (90) on a rear side for housing front part (22) and fixing member (4) of connector (C1) in the connected state where connector (C1) and mating connector (C2) are connected.

According to this aspect, it is possible to provide mating connector (C2) to be connected to connector module (C10) in which the connection reliability of the connection portion between terminal (10) of connector (C1) and conductor (5) of connection target member (C11) is improved.

Connector (C1) according to a seventeenth aspect connects to connection target member (C11), connection target member (C11) including a plurality of conductors (5) and having a plate-like shape and connects to mating connector (C2) by moving relative to mating connector (C2) in a forward-rearward direction. Connector (C1) includes a plurality of terminals (10) to be respectively connected to the plurality of conductors (5) of connection target member (C11), housing (2) that holds the plurality of terminals (10), and fixing member (4). Each of the plurality of terminals (10) includes contact part (101) and connecting part (104). Contact part (101) is in contact with corresponding mating terminal (8) among a plurality of mating terminals (8) of mating connector (C2) in a connected state where connector (C1) and mating connector (C2) are connected. Connecting part (104) connects to corresponding conductor (5) among the plurality of conductors (5) of connection target member (C11). Mating connector (C2) is positioned on a front side with respect to connector (C1), and housing (2) includes, at a front side of housing (2), front part (22) for disposing the plurality of terminals (10). Fixing member (4) is attached to front part (22) of housing (2). Front part (22) and fixing member (4) include a first holding mechanism that holds fixing member (4) with respect to front part (22) at a first position where a distance in an up-down direction between fixing member (4) and the plurality of terminals (10) is relatively long, and a second holding mechanism that holds fixing member (4) with respect to front part (22) at a second position where a distance in the up-down direction between fixing member (4) and the plurality of terminals (10) is relatively short.

According to this aspect, because front part (22) and fixing member (4) have the first holding mechanism in addition to the second holding mechanism, connector (C1) before connection target member (C11) is connected can be easily conveyed in a state where fixing member (4) is temporarily held by front part (22).

What is claimed is:

1. A connector module comprising:
a connector configured to be connected to a mating connector by moving relative to the mating connector in a forward-rearward direction; and
a connection target member configured to be connected to the connector, the connection target member including a plurality of conductors and having a plate-like shape,
wherein
the connector includes:
a plurality of terminals;
a housing that holds the plurality of terminals; and
a fixing member,
each of the plurality of terminals includes:
a contact part that is in contact with a corresponding mating terminal among a plurality of mating terminals of the mating connector in a connected state where the connector and the mating connector are connected; and
a connecting part to be connected to a corresponding conductor among the plurality of conductors of the connection target member,
the mating connector is positioned in front of the connector in the connected state,
the housing includes, at a front side of the housing, a front part for disposing the plurality of terminals,
the connection target member includes:
a first surface facing the connecting part of each of the plurality of terminals; and
a second surface that is a surface opposite to the first surface,
the fixing member is attached to the front part of the housing, and
the fixing member abuts on the second surface of the connection target member.

2. The connector module according to claim 1, wherein
the plurality of conductors of the connecting member include a first conductor and a second conductor, and
the fixing member includes:
a first abutment part that abuts on the first conductor;
a second abutment part that abuts on the second conductor; and
a coupling part that couples the first abutment part and the second abutment part to each other.

3. The connector module according to claim 1, wherein
the fixing member includes a lower opening part, and
the lower opening part exposes a plurality of the connecting parts of the plurality of terminals downward in a state where the connection target member is not disposed in the connector.

4. The connector module according to claim 3,
wherein at least either the fixing member or the front part of the housing includes an upper opening part that exposes the plurality of terminals upward.

5. The connector module according to claim 1, wherein
the fixing member includes:
a lower cover that abuts on the second surface of the connection target member; and
a pair of lateral covers coupled to left and right ends of the lower cover.

6. The connector module according to claim 5,
wherein the fixing member further includes an upper cover coupled to the pair of lateral covers to form a front opening part that is open in the forward-rearward direction.

7. The connector module according to claim 6, wherein
at least either the fixing member or the housing includes:
a lower opening part that exposes the plurality of conductors of the connection target member downward in a state where the connection target member is disposed in the connector; and
an upper opening part that exposes the plurality of terminals upward.

8. The connector module according to claim 5, wherein
the fixing member further includes a pair of projecting wall parts extending in an up-down direction between the pair of lateral covers, and
the pair of projecting wall parts abuts on the front part of the housing.

9. The connector module according to claim 5,
wherein the fixing member includes a projection that abuts on the front part.

10. The connector module according to claim 1,
wherein the fixing member abuts on a mating housing of the mating connector in the connected state where the connector and the mating connector are connected.

11. The connector module according to claim 1, wherein
the connector further includes a seal member disposed along an outer periphery of the front part, and
the fixing member abuts on the seal member in the connected state where the connector and the mating connector are connected.

12. The connector module according to claim 1,
wherein the front part of the housing includes at least one opening part where the fixing member is disposed, the opening part penetrating in an up-down direction.

13. The connector module according to claim 1, wherein
the housing is formed with a through hole penetrating the housing in the forward-rearward direction, and
the connection target member is disposed in the through hole.

14. The connector module according to claim 1, wherein
the connection target member further includes a base material having a plate-like shape provided with the plurality of conductors, and
a laser welding mark is formed at a junction portion between each of the plurality of conductors of the connection target member and the connecting part of a corresponding terminal among the plurality of terminals.

15. A connector device comprising:
the connector module according to claim 1; and
the mating connector,
wherein
the mating connector includes:
the plurality of mating terminals; and
a mating housing that holds the plurality of mating terminals,
and
the front part and the fixing member of the connector are housed in a mating recess that is open to a rear side of the mating housing in the connected state where the connector and the mating connector are connected.

16. A mating connector configured to be connected to the connector module according to claim 1, the mating connector comprising:
the plurality of mating terminals; and
a mating housing that holds the plurality of mating terminals,
wherein
the mating housing includes a mating recess on a rear side for housing the front part and the fixing member of the connector in the connected state where the connector and the mating connector are connected.

17. A connector to be connected to a connection target member, the connection target member including a plurality of conductors and having a plate-like shape, and configured to be connected to a mating connector by moving relative to the mating connector in a forward-rearward direction, the connector comprising:
a plurality of terminals to be respectively connected to the plurality of conductors of the connection target member;
a housing that holds the plurality of terminals; and
a fixing member,
wherein
each of the plurality of terminals includes:
a contact part that is in contact with a corresponding mating terminal among a plurality of mating terminals of the mating connector in a connected state where the connector and the mating connector are connected; and
a connecting part to be connected to a corresponding conductor among the plurality of conductors of the connection target member,
the mating connector is positioned in front of the connector in the connected state,
the housing includes, at a front side of the housing, a front part for disposing the plurality of terminals,
the fixing member is attached to the front part of the housing, and
the front part and the fixing member include:
a first holding mechanism that holds the fixing member with respect to the front part at a first position where a distance in an up-down direction between the fixing member and the plurality of terminals is relatively long; and
a second holding mechanism that holds the fixing member with respect to the front part at a second position where a distance in the up-down direction between the fixing member and the plurality of terminals is relatively short.
